(19) United States
(12) Patent Application Publication
(10) Pub. No.: US 2015/0044383 A1
(43) Pub. Date: Feb. 12, 2015

(54) Resistive Heating Assisted Infiltration and Cure (RHAIC) For Polymer/Carbon Nanotube Structural Composites

(71) Applicant: U.S.A. represented by the Administrator of the National Aeronautics and Space Administration, Washington, DC (US)

(72) Inventors: Jae-Woo Kim, Newport News, VA (US); Godfrey Sauti, Hampton, VA (US); Emilie J. Siochi, Newport News, VA (US)

(21) Appl. No.: 14/328,262

(22) Filed: Jul. 10, 2014

Related U.S. Application Data
(60) Provisional application No. 61/863,227, filed on Aug. 7, 2013.
(60) Provisional application No. 61/955,824, filed on Mar. 20, 2014.

(51) Int. Cl. B05D 1/04; C09K 5/14

(52) U.S. Cl. CPC B05D 1/04; C09K 5/14; Y10S 977/89; B82Y 40/00
USPC 427/427.4; 252/74; 264/164; 427/430.1; 977/890

(57) ABSTRACT

Systems, methods, and devices of the various embodiments provide thermoset (or thermoplastic)/carbon nanotube (CNT) sheet nanocomposites fabricated by resistive heating assisted infiltration and cure (RHAIC) of a polymer matrix resin. In an embodiment, resin infusion may achieved by applying a first lower voltage to a CNT reinforcement. Once the resin infusion process is complete, the voltage may be increased to a second higher voltage which may rapidly cure the polymer matrix. In an embodiment, an epoxy SC-85 and hardener may be used. In another embodiment, present a bismaleimide (BMI) may be used for the matrix material.

### CROSS REFERENCE TO RELATED APPLICATIONS

This application claims the benefit of priority to U.S. Provisional Application No. 61/863,227 filed on Aug. 7, 2013 entitled “Resistive Heating Assisted Epoxy Infiltration and Cure (RHAEIC) for Epoxy/Carbon Nanotube Structural Composites” and U.S. Provisional Application No. 61/955,824 filed on Mar. 20, 2014 entitled “Resistive Heating Assisted Epoxy Infiltration and Cure (RHAEIC) for Epoxy/Carbon Nanotube Structural Composites”, the entire contents of both of which are hereby incorporated by reference in their entireties.

### STATEMENT REGARDING FEDERALLY SPONSORED RESEARCH OR DEVELOPMENT

The invention described herein was made in the performance of work under a NASA contract and by employees of the United States Government and is subject to the C) provisions of Public Law 96-517 (35 U.S.C. §202) and may be manufactured and used by or for the Government for governmental purposes without the payment of any royalties thereon or therefore. In accordance with 35 U.S.C. §202, the contractor elected not to retain title.

### BACKGROUND OF THE INVENTION

Carbon nanotubes (CNTs) show promise as multifunctional materials for a range of applications due to their outstanding combination of mechanical, electrical and thermal properties. The measured elastic moduli for individual CNTs range from 1.28 to 1.8 TPa. CNTs have exhibited breaking strengths ranging from 11 to 63 GPa and failure strain of 1.6% under a tensile load. However, these promising mechanical properties have not translated well to CNT nanocomposites fabricated by conventional methods due to the weak load transfer between tubes or tube bundles as well as between the tubes and the matrix. There is a need for a significant research effort directed toward controlling the nanotube-nanotube and nanotube-matrix interactions, which play a major role in load transfer and electron and phonon transport. Recent developments in this area include the use of in-situ polymerization to introduce a conducting thermoplastic as the binder. Attempts have also been made to use various forms of epoxy as the composite matrix, since this class of materials is common in state-of-the-art composite structures, and therefore well accepted in the aerospace community.

Utilizing the full mechanical capabilities of individual nanotubes is a primary research goal in nanotube reinforced nanocomposite materials. Most studies on structural applications of nanomaterials, such as CNTs, have focused on attempts to improve dispersion in structural matrices to achieve or exceed the performance of state-of-the-art carbon fiber reinforced polymer composites. This approach is limited by the volume of CNTs that can practically be incorporated into the matrix due to extremely high viscosities that result from CNT aggregation, and has yet to yield mechanical properties that compete with carbon fiber reinforced polymers (CFRPs), the aerospace structural material of choice. Further, CNTs have not demonstrated large load carrying capacity in nanocomposites due to poor intertube and tube-matrix load transfer and physical defects created during processing and fabrication. Infiltration of CNT assemblages such as yarns and sheets, with high performance polymers such as epoxies, thermoplastics, etc, is quite challenging due to the higher resin viscosity and poor wettability of CNT assemblages, especially densified formats, by the infused polymers despite using vacuum assisted resin transfer molding (VARTM). Practical use of these nanomaterials will require the development of approaches that create stable and strong adhesion between nanotubes without sacrificing their inherent mechanical properties.

### BRIEF SUMMARY OF THE INVENTION

The present invention relates generally to nanomaterials, and more specifically to thermoset (or thermoplastic)/nanotube structural composites.

The systems, methods, and devices of the various embodiments provide thermoset (or thermoplastic)/carbon nanotube (CNT) sheet nanocomposites fabricated by resistive heating assisted infiltration and cure (RHAIC) of a polymer matrix resin. Resistive heating according to the various embodiments may take advantage of the electrical and thermal conductivity of CNTs to rapidly and uniformly introduce heat into the CNT paper. Heating the CNT sheet may reduce the viscosity of the polymer resin, which may enhance resin flow, penetration and wetting of the CNT reinforcement. In an embodiment, resin infusion may achieved by applying a first lower voltage to the CNT reinforcement. Once the resin infusion process is complete, the voltage (or power) may be increased to a second higher voltage to raise the temperature of the CNT sheet, which may rapidly cures the polymer matrix. In an embodiment, an epoxy SC-85 may be used as the matrix material. In another embodiment, present a bismaleimide (BMI) may be used for the matrix material.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram illustrating a voltage, current, and temperature monitoring and control system set up for RHAIC according to an embodiment.

FIG. 2 is a graph of I-V characteristics of pristine CNT yarns over a 0-10 V run.

FIG. 3 illustrates side by side comparison graphs of the current and the current density carried by pristine CNT yarns.

FIG. 4 illustrates side by side comparison graphs of the heating and current density profiles of a pristine CNT yarn on a repeated set of two sweeps between 0 and 10 V.

FIG. 5 illustrates side by side comparison graphs of the heating and current density profiles of a pristine CNT yarn on two sweeps between 0 and 20 V.

FIG. 6 illustrates side by side comparison graphs of the applied voltage and resulting temperature and instantaneous resistance (V/I) for a 0-20 V run, and the power and temperature characteristics on a pristine CNT yarn with two sets of sweeps in the 0-20 V range followed by two different holding times at 20 V.

FIG. 7 includes photographs showing results of a wetting study of SC-85 resin and hardener on a nitric acid treated CNT sheet without resistive heating.

FIG. 8 includes photographs showing results of a wetting study of a mixture of SC-85 resin and hardener on a nitric acid treated CNT sheet without resistive heating.

FIG. 9 includes photographs showing results of a wetting study of a mixture of SC-85 resin and hardener on a nitric acid treated CNT sheet with resistive heating.

FIG. 10 includes photographs showing results of a wetting and curing study of a mixture of SC-85 resin and hardener on a nitric acid treated CNT sheet with resistive heating.

FIG. 11 includes photographs showing results of a wetting and curing study of a mixture of SC-85 resin and hardener on an acetone treated CNT sheet with resistive heating.

FIG. 12 includes photographs of a SC-95/CNT sheet composite prepared by an embodiment RHAEIC process before and after curing for 90 sec at 5 V.

FIG. 13 is a graph of representative stress-strain curves of a processed SC-85/nitric acid treated CNT sheet nanocomposites under a tensile load.

FIG. 14 is a graph of representative stress-strain curves of a processed SC-85/acetone acid treated CNT sheet nanocomposites under a tensile load.

FIG. 15 includes high resolution scanning electron microscope (HR-SEM) photographs of SC-85/CNT sheet nanocomposites showing a surface, partially failed surface under a tensile load, cross sectional after failure, and a failed side.

FIG. 16 illustrates an embodiment method for RHAIC fabrication of polymer/carbon nanotube sheet nanocomposites.

FIG. 17 illustrates comparison graphs of applied current versus temperature and applied power versus temperature with CNT sheets during BMI infiltration and cure by resistive heating while a pristine CNT sheet is loaded in a mechanical stretched, stretched to a desired level, infiltrated with resin, and cured by resistive heating.

FIG. 18 includes 2-D IR photographs of a representative temperature at a certain location during RHAIC.

FIG. 19 illustrates comparison graphs of the specific strength and specific modulus of pristine CNT sheet and BMI/CNT sheet nanocomposites in terms of a level of stretching.

FIG. 20 shows low magnification (×5K) HR-SEM photographs of as-received, 31.2% stretched pristine CNT sheets, and BMI/stretched CNT sheet nanocomposites cured by thermal and RHAI followed by post-thermal cure.

FIG. 21 shows high magnification (×100K) HR-SEM photographs of as-received, 31.2% stretched pristine CNT sheets, and BMI/stretched CNT sheet nanocomposites cured by thermal and RHAI followed by post-thermal cure.

FIG. 22 is an isometric view of an embodiment moveable electrical conductive roller system for RHAIC processing of unlimited length material.

FIG. 23 is an isometric view of an example component formed by embodiment RHAIC processing.

FIG. 24 is an isometric view of an object being repaired by embodiment RHAIC processes.

FIG. 25 is an isometric view of an embodiment RHAIC device.

FIG. 26 shows FE-SEM pictures of SC-85/CNT sheet nanocomposites including a cross-section after tensile failure, a CNT rich bottom, and a resin rich top surfaces, as well as representative stress-strain curves of the processed SC-85/CNT sheet nanocomposites under a tensile load.

FIG. 27 shows wetting and curing studies of BMI resin on a pristine CNT sheet with resistive heating.

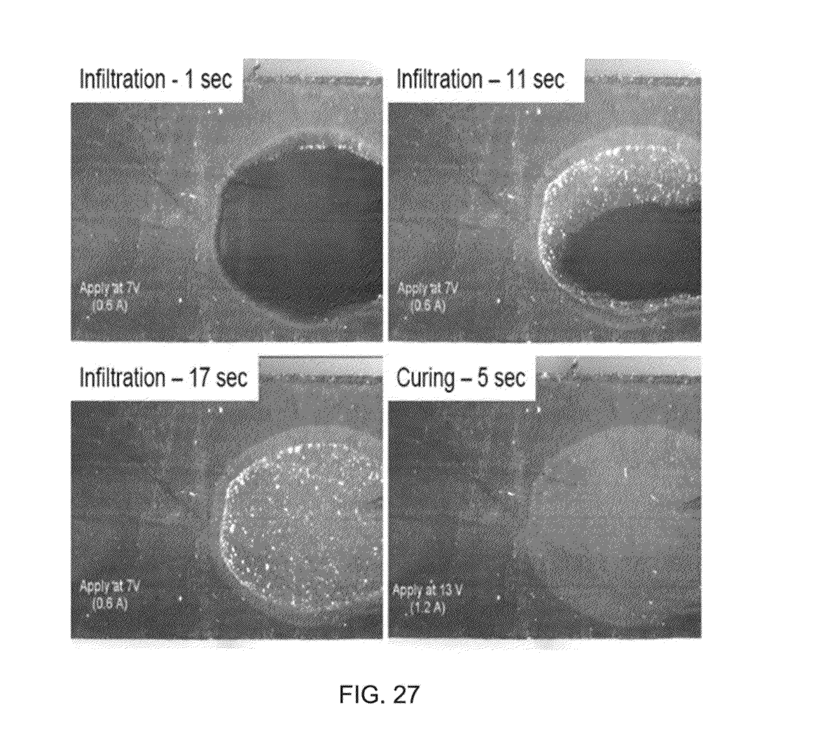

FIG. 28 is a graph of representative stress-strain curves of a pristine CNT sheet and processed BMI/CNT sheet nanocomposites fabricated by thermal cure and RHAIC, where all BMI/CNT sheet nanocomposites were fabricated with a stretched (33.9%) CNT (S-CNT) sheet.

FIG. 29 illustrates comparison graphs of the specific strength and the specific modulus of pristine and stretched CNT sheets and processed BMI/CNT sheet nanocomposites in terms of the level of stretching, where the BMI/CNT sheet nanocomposites were fabricated by thermal cure, RHAIC, and RHAI followed by post-thermal cure, and the starting pristine CNT sheet was acetone treated from Lot#5682-A.

FIG. 30 illustrates comparison graphs of the specific strength and the specific modulus of pristine and processed BMI/CNT sheet nanocomposites in terms of the level of stretching, where the BMI/CNT sheet nanocomposites were fabricated by RHAI followed by post-thermal cure or press mold cure under a tension, and the starting pristine CNT sheet was an acetone treated one from Lot#70044.

FIG. 31 is FE-SEM pictures of the BMI/CNT sheet (1 ply and 36% stretched) nanocomposites fabricated by RHAI followed by thermal cure showing the cross-sectional and top surface after tensile failure, as well as the BMI/CNT sheet nanocomposite processed by RHAI followed by press-mold cure fabricated with 2 layers of CNT sheet (42% stretching) and its cross sectional and tilted FE-SEM images taken at a failure site.

FIG. 32 illustrates comparison graphs of FTIR spectra of uncured BMI/CNT and as-prepared BMI/CNT sheet nanocomposites via thermal cure, RHAIC, RHAI followed by thermal cure, and press-molded cure and DSC thermographs of as-prepared BMI/CNT sheet nanocomposites via thermal cure, RHAIC, RHAI followed by thermal cure, and press-molded cure.

### DETAILED DESCRIPTION OF THE INVENTION

For purposes of description herein, it is to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

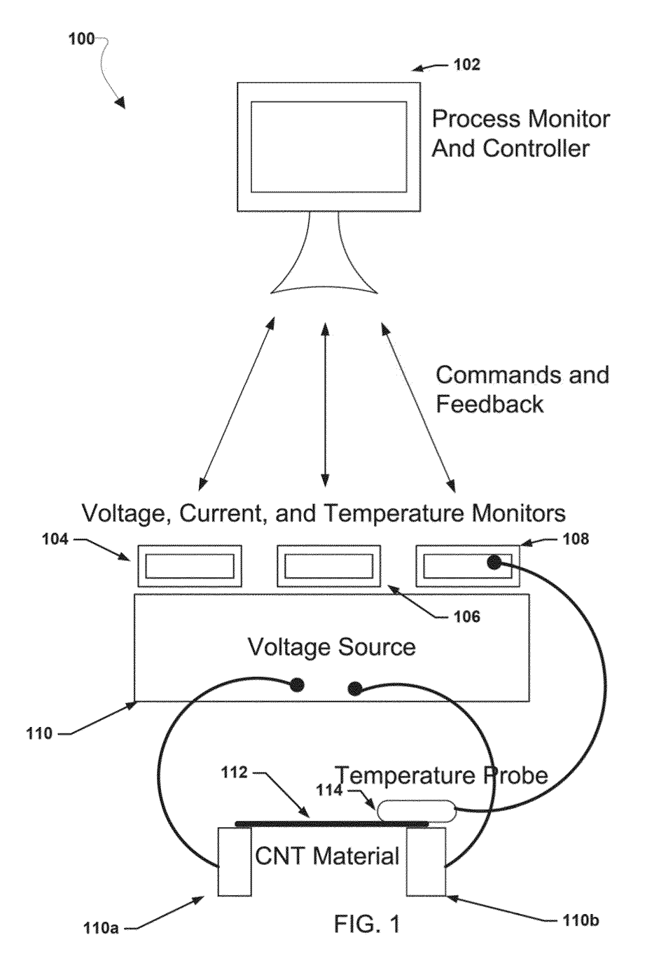

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The word “exemplary” is used herein to mean “serving as an example, instance, or illustration.” Any implementation described herein as “exemplary” is not necessarily to be construed as preferred or advantageous over other implementations.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

CNTs are one-dimensional nanomaterials that have been touted for their outstanding combination of mechanical, electrical, and thermal properties. There is great interest in using them in lightweight structural applications because individual CNTs exhibit superior tensile elastic modulus (˜1 TPa) and breaking strength (˜100 GPa) on the nanoscale. While there has been some success in exploiting their electrical properties, the promising mechanical properties have not translated well to the macroscale for CNT nanocomposites fabricated using conventional methods. This is primarily due to weak load transfer and interfacial barriers, both between tubes or tube bundles, and between the tubes and the polymer resin. Most studies on structural applications of CNTs have focused on attempts to improve CNT dispersion in engineering polymer matrices to achieve enhanced mechanical properties of the resulting nanocomposites. This approach to enhancing nanocomposite mechanical properties is limited by the small volume of CNTs that can practically be incorporated into the matrix without causing extremely high viscosities that impede processing of the nanocomposite precursor. Achieving mechanical properties that are competitive with the state-of-the-art carbon fiber-reinforced polymer (CFRP) composites will require higher loading levels, improved intertube and tube-resin load transfer, and the minimization of physical defect creation during processing and fabrication.

While recent developments in high-volume manufacture of CNT sheets and yarns are improving the availability of these materials, infiltration of CNT assemblages such as yarns and sheets, with high performance thermoset and thermoplastic polymers is quite challenging due to high resin viscosity, poor wettability, and low permeability of CNT assemblages. These CNT forms exhibit small pore sizes (˜10 nm) and high tortuosity resin flow paths, especially in highly densified formats. For example, the through-thickness permeability of CNT sheets to epoxy resin is very low (10⁻¹⁷ to 10⁻¹⁹ m²), which results in void formation from trapped air in the processed materials, even when using enhanced processing techniques like vacuum assisted resin transfer molding (VARTM). Other processing techniques, such as in-situ polymerization of polymer binders and the direct application of a polymer resin during continuous drawing of aligned CNTs from spinnable CNT forests are being explored, but require further development.

Numerous heating methods of composites have been used in the literature to promote both polymer resin infusion and cure. Beyond conventional autoclave oven based approaches, microwave, infrared, ultrasonic, and inductive heating have also been used. The latter methods allow for the targeted heating to specific zones, potentially minimizing the overall energy requirements. Because of the great difference in CNT and polymer thermal conductivity, heating tends to be greatest at this interface, which improves both polymer mobility and cure. This has the beneficial effect of improving matrix/CNT interactions in that area that is critical to nanocomposite mechanical properties. These techniques also allow for the fabrication of large structures because they operate outside the confines of conventional ovens. A related technique, resistive heating, has been developed as an approach for repairing localized damage in carbon fiber reinforced Surlyn® ionomer composites. Joule heating results from the application of current to the carbon fibers, which, in turn, heats the ionomeric matrix to permit spontaneous damage repair. Like carbon fiber, CNT sheets and yarns are excellent thermal and electrical conductors, making them amenable to resistive heating. However in the present study, the heating is used for composite processing rather than damage repair.

In the various embodiments, high CNT content (>50 wt. %) nanocomposites may be fabricated from CNTs sheet material using either SC-85 (a two-part epoxy system) or BMI for the matrix resin. A key step in the various embodiments is the introduction of resistive heating assisted infiltration and cure (RHAIC) to improve resin infiltration through the CNT sheet and interfacial adhesion between the CNTs and the infiltrated resin to improve mechanical properties. RHAIC is a single, consolidated process that 1) integrates mechanical stretching of the CNT sheet to physically align the nanotubes, 2) efficiently infuses a minimum volume of resin to bond the aligned CNTs, 3) post-stretches the pre-dried “prepreg”, and 4) cures the resin to complete the fabrication of the CNT nanocomposite with optimal mechanical properties. The significance of this consolidated process is that all the necessary elements for maximizing the mechanical properties of CNT nanocomposites from CNT sheets are accomplished with a single, simple set-up.

In the various embodiments, the structured carbon nanotube forms, such as sheet, yarn, tape, etc., may be modified with epoxy, such as SC-85, to fabricate nanocomposites. A key difference between the various embodiment methods described herein and established practice may be the introduction of RHAIC. The epoxy modified CNT nanocomposites fabricated by RHAIC show improved wetting and adhesion of epoxy onto the CNT surfaces leading to the significant improvement in mechanical property results not exhibited by conventionally prepared epoxy nanocomposites.

Resistive heating takes advantage of the electrical and thermal conductivity of CNTs to effectively and fairly simply introduce heat which promotes the viscosity reduction of the epoxy resin, thus enhancing resin flow, penetration and interaction with the CNT reinforcement.

To understand the mechanical properties of the fabricated SC-85/CNT nanocomposites, mechanical tests were conducted under a tensile load. The tests demonstrated a significant improvement in the mechanical properties of the SC-85/CNT nanocomposites resulting from improved wetting and adhesion of the epoxy matrix. Various embodiments may provide a two-step RHAIC process involving heating at a first lower voltage to transport the epoxy into the structural CNT materials and followed by instantaneous curing with application of a second higher voltage used to complete the fabrication of CNT structural composites. The highest specific tensile strength of the SC-85/CNT sheet nanocomposite as shown by testing thus far is 284 MPa/(g/cm³) fabricated by RHAIC at 4 V and then post cured at 75° C. The highest specific Young's modulus as shown by testing thus far is 10.1 GPa/(g/cm³), which was measured on a sample formed by RHAIC at a first lower voltage of 4 V and then followed by a resistive heating curing at a second higher voltage of 7 V.

In an embodiment, the CNT starting material used may be in the form of either a CNT sheet (untreated, acetone treated, and nitric acid treated CNT sheets) or a yarn (both from Nanocomp Technologies, Inc.). Nanocomposites may be formed by painting the structural CNT material with epoxy, such as SC-85 (a resin and hardener mixture), followed by RHAIC involving a combination of reducing viscosity (e.g., wetting and adhering) with application of a lower voltage and instantaneous curing (e.g., locking of CNT networks or arrays) at higher voltage through the sample.

In a specific embodiment, the sheet or yarn may be first painted with epoxy containing SC-85 resin and a hardener. The controlled voltage may then be applied through the sample to increase its temperature by a resistive heating, with the current through the sample being monitored. Voltage, current, and temperature monitoring and control system 100 set up for RHAIC is illustrated in FIG. 1. The system 100 may comprise a computing device 102 including a processor connected to a voltage sensor 104, current sensor 106, temperature sensor 108, and voltage source 110. The processor of the computing device 102 may be configured with processor-executable instructions to perform operations to control the voltage source 110 to apply two or more different voltages (such as a first lower voltage and a second higher voltage) to an epoxy painted reinforcement material 112 (such as a CNT sheet or yarn painted with SC-85 resin and a hardener) connected between the two or more leads 110a and 110b. The processor of the computing device 102 may also be configured with processor-executable instructions to perform operations to monitor the voltage, current, and/or temperature of the epoxy reinforced material 112 via various sensors and probes, such as a temperature probe 114, and control the voltage source 110 based on the monitored voltage, current, and/or temperature values. The applied voltage may change the epoxy rheology by controlling the sample temperature thus resulting in improved wettability and adhesion of the epoxy onto the CNT surfaces. Further increasing the applied voltage may result in curing the epoxy to lock the CNT networks or arrays.

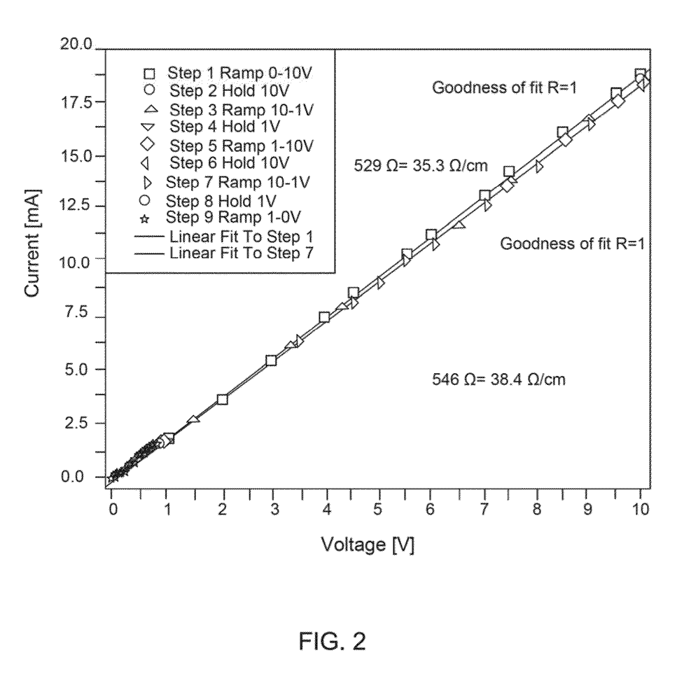

FIG. 2 shows I-V characteristics of pristine CNT yarns over a 0-10 V run. The I-V curves are highly linear with minor hysteresis between the first 0-10 V run and subsequent runs which are then identical. This repeatability and any deviation from it, when an epoxy is applied, may form the basis for monitoring and controlling the RHAIC process. Electrical conductivity and resistivity of the tested CNT yarns are summarized in Table 1.

TABLE 1

| Sample | Diameter [mm] | Length [mm] | Resistance [Ω] | R/L [Ω/cm] | Resistivity [Ω · cm] | Conductivity [S/cm] |
|---|---|---|---|---|---|---|
| 1 | 0.06354 | 25.0 | 155.6 | 62.2 | 0.00197 | 507 |
| 2 | 0.06439 | 25.0 | 170.0 | 68.0 | 0.00221 | 452 |
| 3 | 0.05900 | 24.0 | 177.5 | 74.0 | 0.00202 | 495 |
| 4 | 0.06089 | 25.0 | 171.5 | 68.6 | 0.00200 | 501 |
| 5 | 0.05800 | 23.5 | 162.8 | 69.3 | 0.00183 | 546 |
| 6 | 0.06393 | 24.0 | 153.8 | 64.1 | 0.00206 | 486 |

As illustrated in Table 1, the electrical conductivity of the tested CNT yarns may be around 500 S/cm, such as between, 452 S/cm and 507 S/cm. The CNT yarns may handle a maximum current density of 3000 A/cm² without physical failure as demonstrated in tests of maximum current density carried by the pristine CNT yarns, the results of which are illustrated in graph 300 of current versus electric field and graph 302 of current density versus electric field.

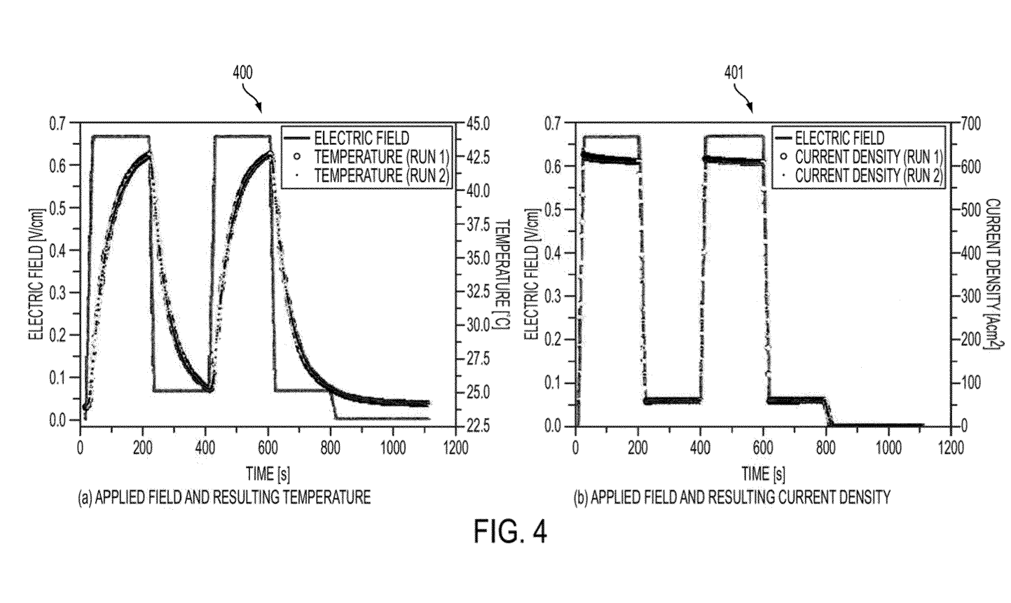

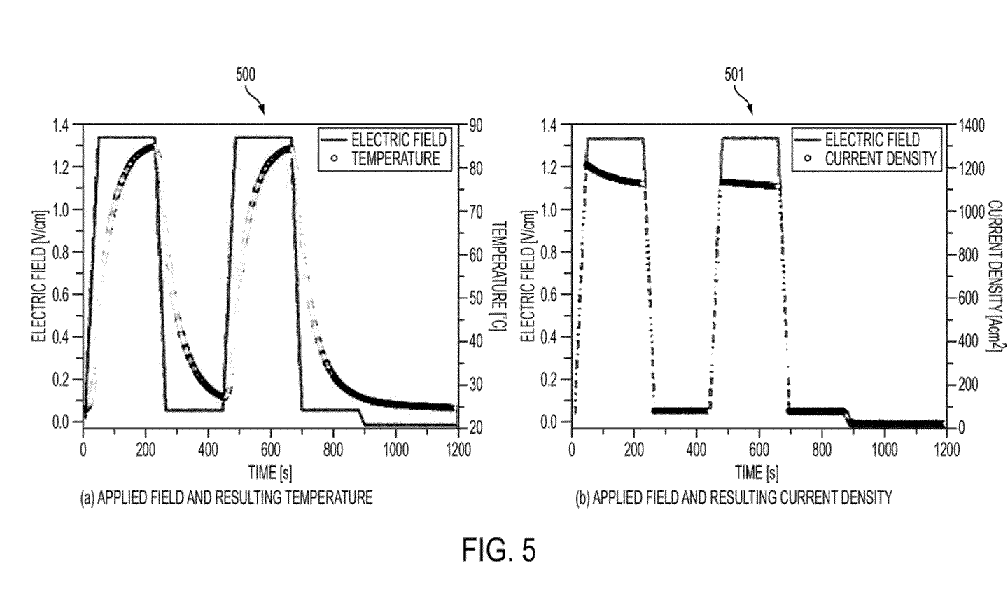

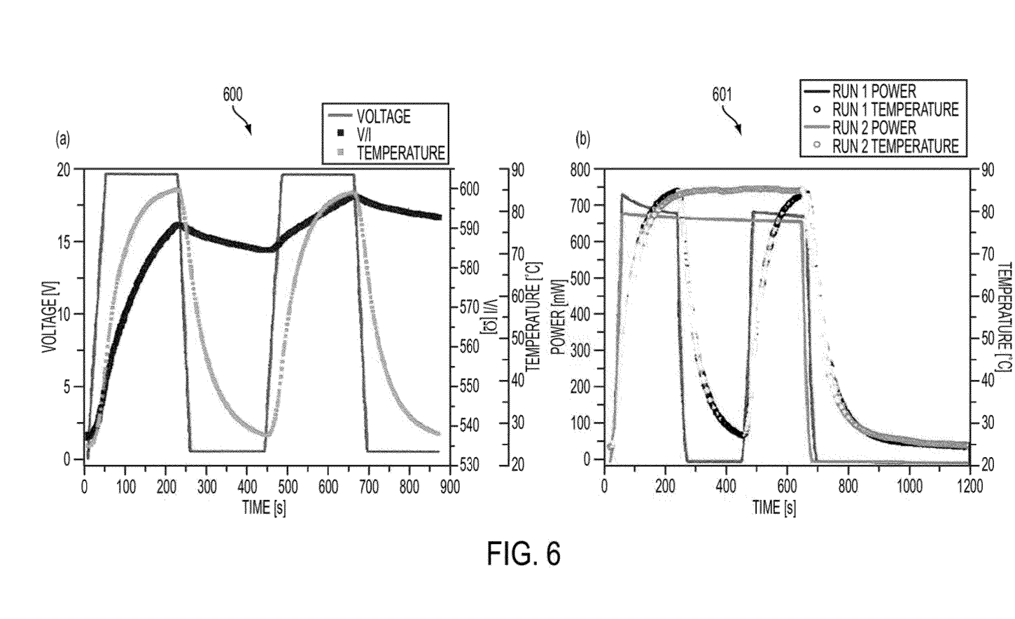

FIGS. 4, 5 and 6 illustrate graphs 400, 401, 500, 501, 600, 601 showing electrical and heating characteristics of the pristine CNT yarns during voltage sweeps. The applied voltage is represented at the electric field (E=V/L) to account for the specimen length (L). Varying the applied voltage (electric field) may allow repeatable control of the sample temperature between room temperature and 85° C., the temperature being determined by wrapping the yarn around a PT100 resistive thermometer element. Note that the relatively poor thermal coupling between the very thin yarn and temperature sensing element leads to the maximum temperature figure being somewhat lower than the actual yarn temperature attained, but the trends can be assessed. The control and repeatability of the heating profile may be achieved for different stages in a cycle, as well as between runs. For these tests, which were conducted in ambient air, the maximum temperature remains the same even at longer holds at 20V, which presumably results in greater total energy input on the 2nd heating step (FIG. 6). This indicates that there is equilibrium with rate of heat input matched by the heat loss. Raising the temperature could be achieved by raising the input power or reducing the rate of heat loss.

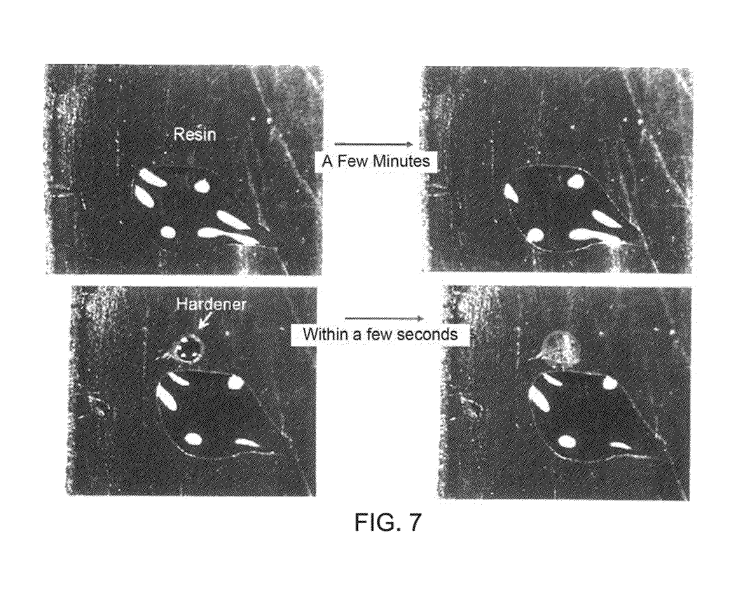

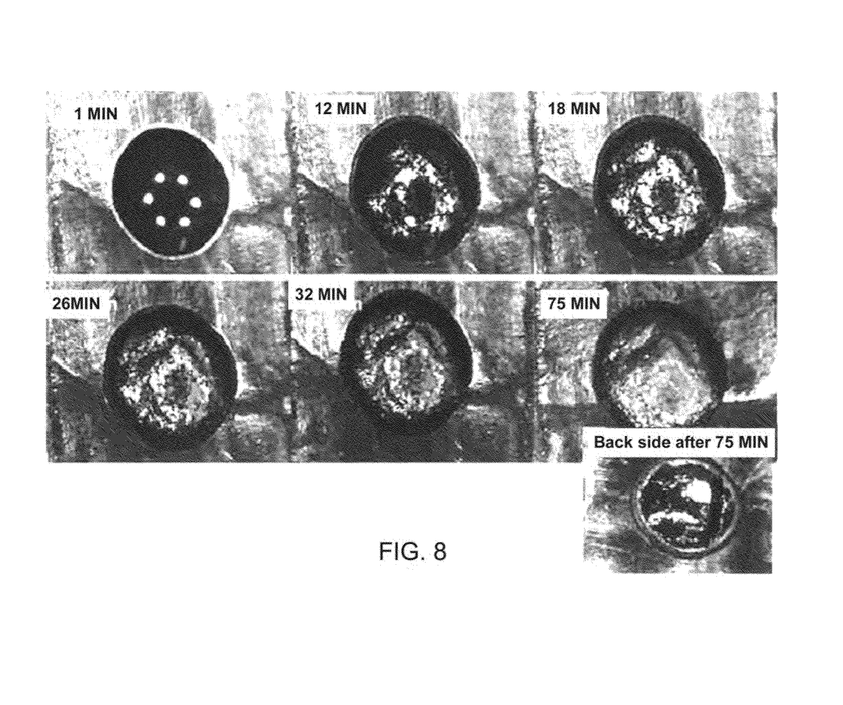

Without a resistive heating assistance, it was not possible for the SC-85 resin to wet both pristine and nitric acid treated CNT sheets, while the hardener which is of much lower viscosity easily wets the CNT sheet within a few seconds as shown in FIG. 7. Mixing the resin and hardener still yields viscosities too high for the mixture to barely wet the CNT sheet surface after it is applied; the resin bead begins to cure over time without significant penetration into the CNT sheet and the mixture of SC-85 was mostly hardened after 75 min (see FIG. 8). Note however, that the hardener penetrates through the CNT sheet and accumulates on the backside of the sheet (shiny residue on the backside surface), suggesting that in the span of the experiment, the viscosity mismatch between the two components of SC-85 caused phase separated into the resin and hardener due to different chemical affinities with CNTs and viscosity of the components. The resin is more viscous than the hardener in the SC-85 resin system.

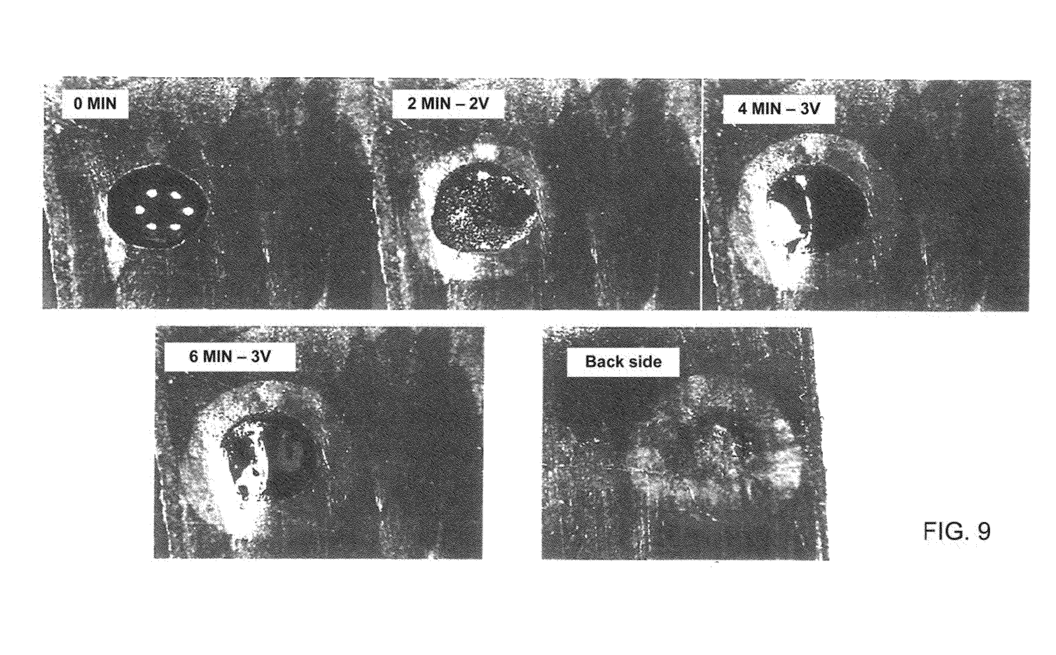

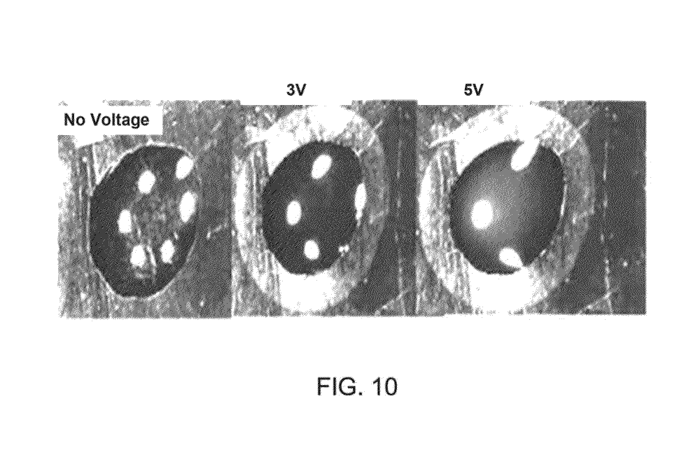

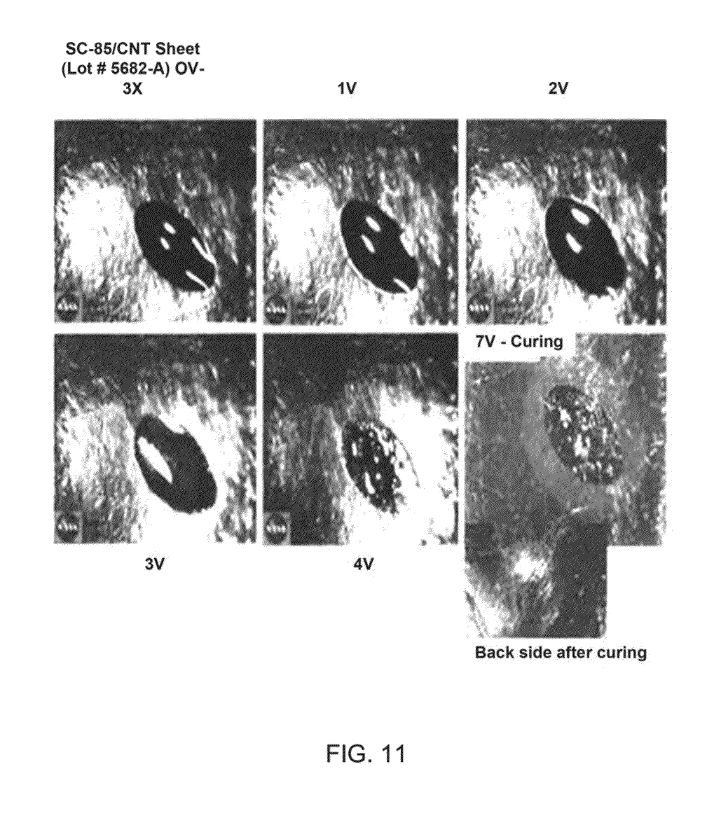

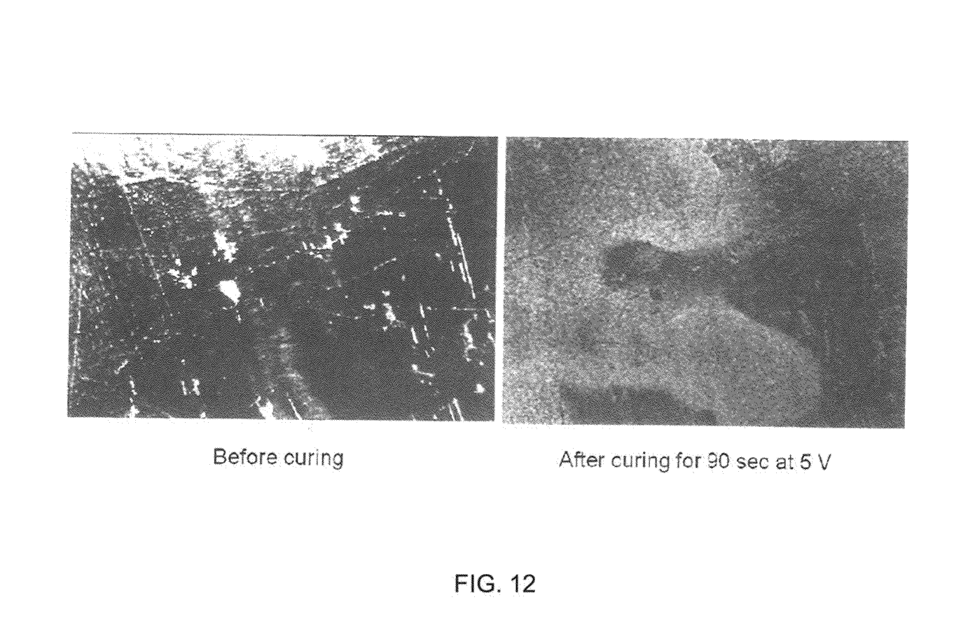

In contrast, the mixture of resin and hardener completely wetted through the CNT sheet with resistive heating assistance at 3 V as shown in FIG. 9. FIG. 10 shows optical microscopic images of wetting and curing indicated by color changes at different applied voltages through the sheet. The lower applied voltage (3V) increases the temperature of the CNT sheet by resistive heating to afford a lower viscosity for the mixture, while the higher applied voltage (5V) effects the cure of the mixture. Similar observations were made with highly densified CNT sheets, especially with the acetone treated CNT sheet (FIG. 11). Note that the mark for the hardener puddle is not visible on the backside of the sheet when the RHAIC method reduced the resin viscosity via resistive heating. The applied SC-85 cured within a few minutes at 5 V when the resin was applied to a strip of CNT sheet as shown in FIG. 12.

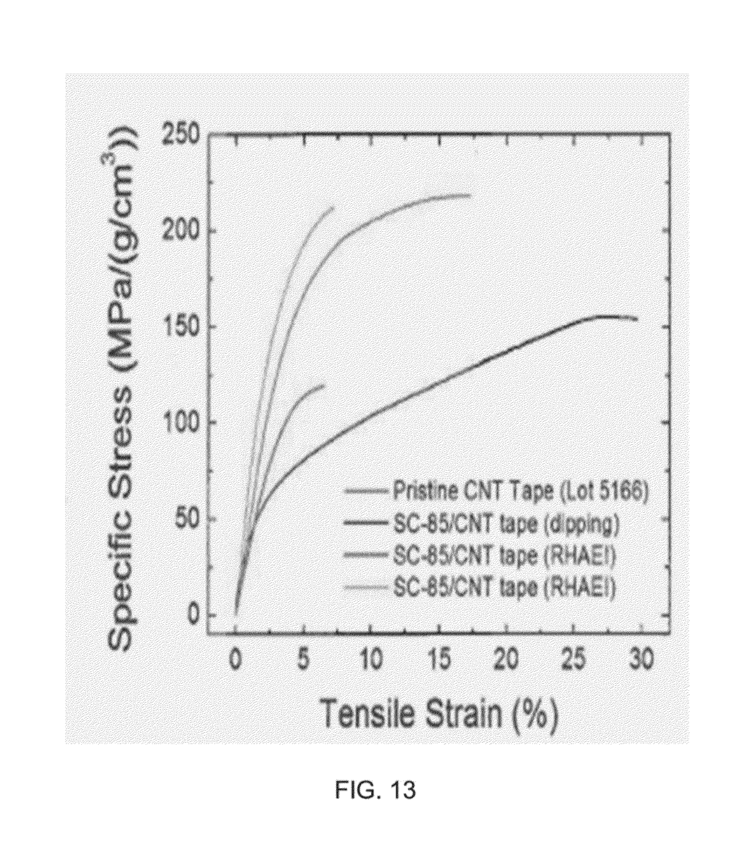

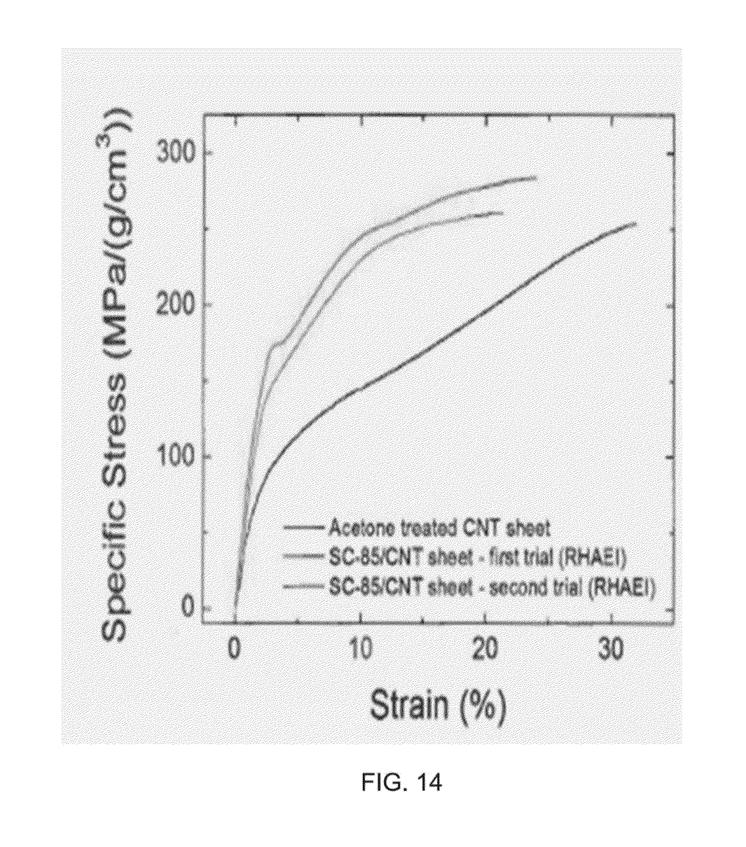

The SC-85/CNT nanocomposites were mechanically tested using a micro tensile tester. An Instron 5848 Microtester was used to measure force-displacement data used to calculate specific elastic modulus (Young's modulus), specific ultimate strength and ultimate tensile strain. The tensile stress was calculated by dividing the measured force by the cross-sectional area of the SC-85/CNT sheet nanocomposites determined with a profilometer type instrument that measures film thickness and confirmed by microscopic measurements. All data were normalized by the density of the SC-85/CNT sheet nanocomposites which was determined by measuring the length, width and thickness of the sheet and weighing the specimen. The tensile testing methods were modified from ASTM standards including D882 (standard test method for tensile properties of thin plastic sheeting), D638 (standard test method for tensile properties of plastics), and D1708 (standard test method for tensile properties of plastics by use of microtensile specimens). The gage length was set at 10 mm for the SC-85/CNT sheet nanocomposites under a tensile load. A crosshead speed was set at 10 and 0.5 mm/min for pristine and SC-85/CNT sheet nanocomposites, respectively. The Young's modulus was obtained by linear regression at the maximum slope of the corresponding stress-strain curve. The fabricated SC-85/CNT sheet composites and their mechanical properties are summarized in FIGS. 13 and 14. The measured specific tensile strength and specific Young's modulus of the nitric acid treated CNT sheets (Nanocomp Technologies, Inc.) were 156±11 MPa/(g/cm³) and 6.1±1.5 GPa/(g/cm³) respectively, and the strain at failure was 30±8%. The mechanical properties of SC-85/CNT composite fabricated by a brushing without RHAIC is poor for both the tensile strength (119 MPa/(g/cm3)) and modulus (3.4 GPa/(g/cm³)). The specific tensile strength of SC-85 fabricated by RHAIC was 215 MPa/(g/cm³) and further increased when applied to a highly densified CNT sheet (284 MPa/(g/cm³)). The Young's modulus also increased to 10.1 GPa/(g/cm³). The specific tensile strength at lower strain (below 10%) dramatically increased with the SC-85/CNT composites prepared by RHAIC due to better adhesion of the resin to the CNT surfaces. Also, the nanocomposites fabricated by the RHAIC (55 J/g) show an improved toughness compared with those of the nitric acid treated (35 J/g) and acetone treated CNT sheets (51 J/g).

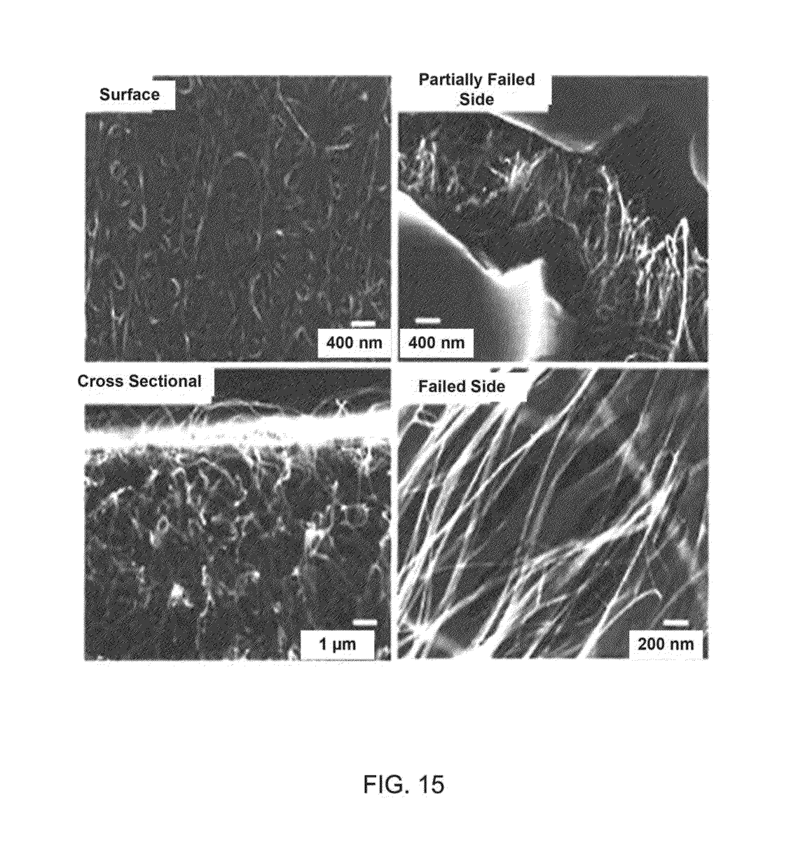

Overall, the SC-85/CNT sheet nanocomposites fabricated by RHAIC were well coated by the resin through the CNTs surfaces and interconnected between the CNT bundles through the thickness of the film (FIG. 15). This method has high potential for much more significant enhancements of mechanical properties for CNT composites when used with purified, more aligned stretched CNT sheets where load transfer is anticipated to be even more effective. This method may not be limited to epoxy matrices, but can be applied with other classes of polymers where an increase in resin temperature yields a lower viscosity. Further, while the example here is on CNT sheets, this method can be applied to reinforcements such as carbon fibers which are also conductive, albeit less so than CNTs.

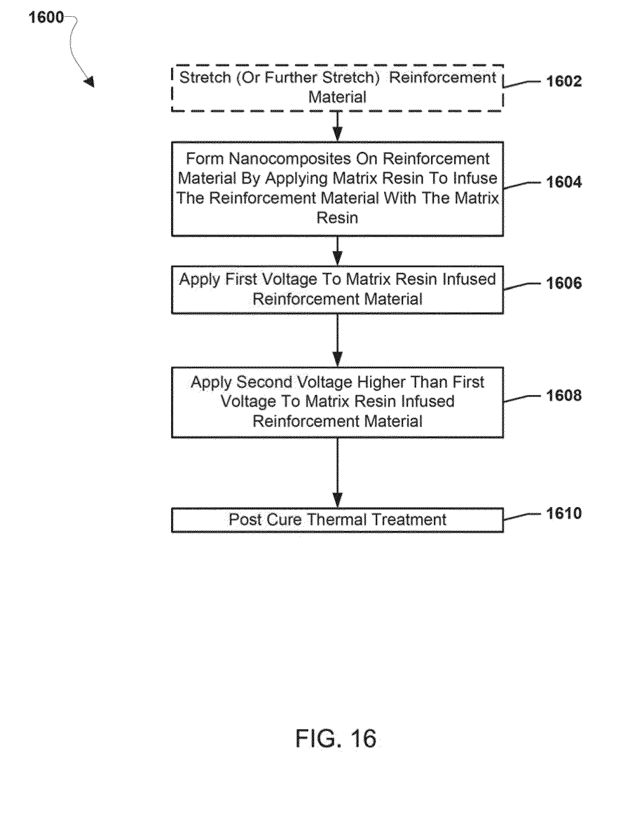

FIG. 16 illustrates an embodiment method 1600 for RHAIC fabrication of epoxy/carbon nanocomposites, such as epoxy/carbon nanotube structural composites. A reinforcement material may be provided unstretched or pre-stretched (such as stretched at least 30% or more). As examples, the starting material may be a reinforcement material that is an unstretched (e.g., as prepared or “pristine”) CNT sheet or a pre-stretched CNT sheet. In optional block 1602 a reinforcement material may be stretched or further stretched. In various embodiments, the reinforcement material may be any CNT assemblage, such as an untreated, acetone treated, nitric acid treated, purified, or chemically modified CNT sheet, CNT yarn, or CNT tape. In another embodiment, the reinforcement material may be carbon fibers. Stretching or further stretching the reinforcement material, such as by 30% or more, may be optional before performing further operations. In block 1604 nanocomposites may be formed on the reinforcement material by applying matrix resin to the reinforcement material to infuse (or infiltrate) the reinforcement material with the matrix resin. In various embodiments, the matrix resin may be a thermoset, such as an epoxy, or any other type of thermoset, or a thermoplastic. For example, the thermoset may be a two part resin, such as a two part resin SC-85 having both resin epoxy and a hardener component. In various embodiments, the thermoset may be a one part resin, such as a bismaleimide (BMI) resin. In other embodiments, the matrix resin may be a thermoplastic polymer. In various embodiments, the matrix resin may be dissolved in a solvent. For example, the BMI resin may be dissolved in toluene, methyl ethyl ketone (MEK), etc. The matrix resin may be applied in any manner, including by painting the matrix resin on the reinforcement material, spraying the matrix resin on the reinforcement material (e.g., spray coating), dipping the reinforcement material in matrix resin, soaking the reinforcement material in matrix resin, etc. In block 1606 a first voltage may be applied to the matrix resin infused reinforcement material to increase its temperature by resistive heating. As examples, the first voltage may be 2 V and 10 V, such as 2 V, 3 V, 4 V, 8.3 V, 10 V, etc. The first voltage may be applied to improve the wettability and adhesion of the matrix resin onto the reinforcement material surfaces. In block 1608 a second voltage higher than the first voltage may be applied to the matrix resin infused reinforcement material to cure the matrix resin. As examples, the second voltage may be between 5 V and 20 V, such as 5 V, 7 V, 12.5 V, 13 V, 20 V, etc. The applied voltage and current were determined by amount of CNT sheet and distance between two applied electrodes. In optional block 1610 a post cure thermal treatment may be applied. The post cure thermal treatment may only be needed if desired. As a general example, the post cure thermal treatment may comprise heating the matrix resin infused reinforcement material to temperatures as high as (or up to) 300 degrees Celsius for at least two hours. As a specific example, the post cure thermal treatment for the matrix resin, such as BMI, may be to heat the nanocomposite to 240 degrees Celsius for 6 hours.

In various embodiments, only after the second voltage is applied in block 1608 and/or the post cure thermal treatment is completed, may the reinforcement material be stretched or further stretched. In various embodiments, during the pre-cure step (e.g., RHAI at the increase cure voltage), the reinforcement material may be stretched or further stretched (whether previously unstretched or previously stretched) to improve the mechanical properties by further alignment of the CNT networks. As an example, the reinforcement material may be further stretched until the pre-cure step is completed.

To improve the thermal conductivity of the resin and thus the fusion with the CNT sheets and mechanical interlocking, in an embodiment the resin may be doped with low concentrations (0-20 wt %) of well dispersed thermally (and electrically conductive) carbon nanotubes (CNTs) and graphene sheets or thermally conductive and electrically insulating boron nitride nanotubes and nano sheets. This doping, which can be achieved by mixing and ultrasonication, provides a matrix with tailored thermal properties for the RHAIC process. In this manner, the matrix resin may comprise a resin and a loading of fillers, such as carbon nanotubes, grapheme sheets, boron nitride nanotubes, boron nitride nanosheets, or other fillers, selected to improve the resin's thermal conductivity and mechanical interlocking properties. In an embodiment, the loading of fillers may be between 0 and 20 wt %.

The various embodiments may viably use epoxy to form stable binding between the CNT tubes and bundles by RHAIC. In the various embodiments the mechanical properties of SC-85 modified CNT sheets or yarns may be comparable with those of currently available structural materials such as CNT yarn and CNT/polymer composites. The various embodiment approaches of epoxy modification with RHAIC represents one possible approach for transferring load between the tubes and bundles for future structural material designs. The various embodiments may provide utilization of efficient resistive heating for high viscosity resin systems, not limited to epoxies. The various embodiments may provide utilization of efficient resistive heating conductive reinforcements not limited to carbon nanofillers. The various embodiment methods and systems may provide voltage, current and temperature monitoring and feedback to achieve end product quality control by a closed loop control. AC and/or DC voltages and monitoring tools may be used to achieve the desired levels of power delivery and control in various embodiment methods and systems. The various embodiments may be combined with mechanical stretching machine and CNT alignment monitoring by Raman spectroscopy during stretching to provide enhanced processing capabilities, monitoring and control feedback. The various embodiments may be combined with the-state-of-the-art structural fabrication processes such as vacuum assisted resin transfer molding (VARTM). The various embodiments may provide reduced processing time (minute vs. hours) and may not require a high temperature autoclave facility. With the inherent control of resin flow and curing, instant feedback, via the power supply and monitoring system, and near instantaneous cure, the embodiment RHAIC may be used as part of an additive manufacturing process.

The various embodiments may provide commercial applications including: light weight structural materials for aerospace vehicles including high altitude aerospace flights and space exploration; electromagnetic interference shielding materials including automobile, solar energy housing and buildings, cosmetics, clothing, blankets, helmets, etc.; military applications such as light weight armor; lightning protection for aerospace vehicles; flexible structural materials; application to the various shapes of parts curing and repairing by RHAIC; thermally conductive material applications; high temperature resistive heating materials; and RHAIC with the inherent control of resin flow and curing including near instantaneous cure may be used as part of an additive manufacturing process. Additionally, the various embodiments may provide an approach to binding nanotubes together in high performance materials for structural applications.

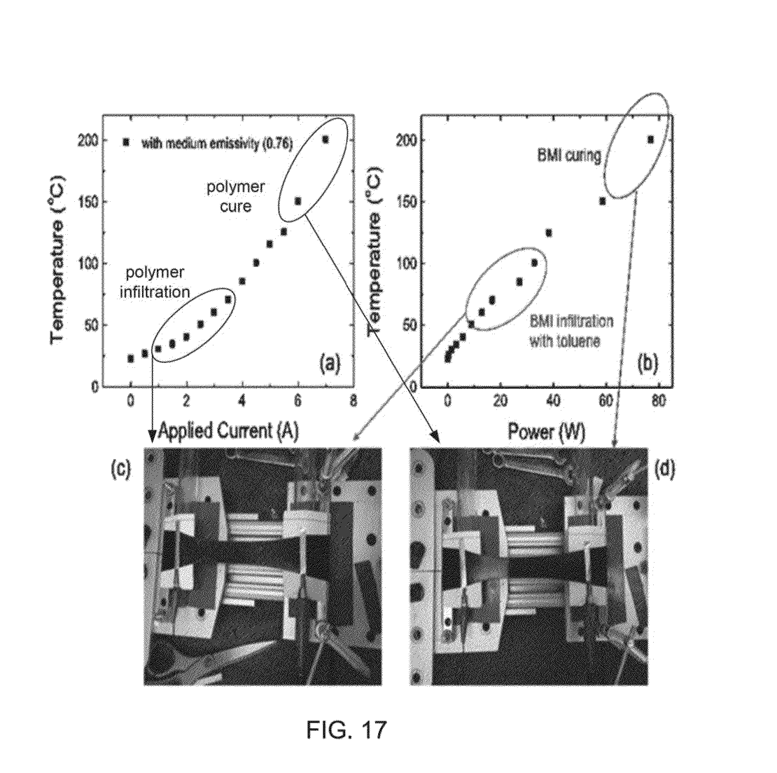

The CNT starting material used in the various embodiments may be in the form of either a CNT sheet (untreated, acetone treated, purified, and chemically modified CNT sheets) or its mechanically stretched CNT sheets. In various embodiments, nanocomposites may be formed by painting the structural CNT material with bismaleimide (BMI) in solvents such as, but not limited to toluene, methyl ethyl ketone (MEK), etc., with various concentrations (0.01˜10 wt. %), followed by resistive heating assisted infiltration and cure (RHAIC) involving a combination of reducing viscosity (wetting and adhering) with application of a lower voltage and instantaneous curing (locking of CNT networks or arrays) at higher voltage through the sample (see FIG. 17). The controlled voltage was then applied through the sample to increase its temperature by resistive heating with the current through the sample being monitored. The applied voltage changes the epoxy rheology by controlling the sample temperature thus resulting in improved wettability and adhesion of the epoxy onto the CNT surfaces. Further increasing the applied voltage results in curing the epoxy to lock the aligned CNT networks or arrays. The process demonstrates a single, consolidated process for mechanically stretching a CNT sheet to induce physical alignment of CNTs, efficiently applying resins including infiltration of the minimum volume of resin and enhanced adhesion between matrix resin and CNTs, post-stretching of pre-dried prepreg, and curing of the resin to complete the fabrication of a CNT nanocomposite with optimal properties. The significance of this consolidated process is that all the necessary elements for maximizing the mechanical properties of CNT nanocomposites from CNT sheets (stretching to align CNTs, applying the minimum amount of resin while completely wetting the CNTs, curing of the matrix resin to lock in alignment of the CNT tubes for effective load carrying capability as evidenced by significant enhancement of tensile properties of the resulting nanocomposite) may be accomplished by a single method. Current practice to achieve the analogous results requires 1) mechanically stretching the CNT sheet, 2) applying the matrix resin by painting, soaking or spraying a resin solution, 3) pre-drying the coated sheet, and 4) consolidating pre-dried sheets to complete the curing and fabrication of the nanocomposite. At a minimum this 4-step process needs to be carried out in 3 apparatuses—steps 1 and 2 can be carried out in a mechanical stretcher equipped with sprayer, step 3 requires transferring the coated sheet into an oven and step 4 needs to be completed in a press. The entire fabrication process requires more than one day to complete.

Various embodiments for RHAIC differ from the current practice in that the various embodiments of RHAIC may be done in a single device as shown in FIG. 17 and the materials processing may be completed within an hour.

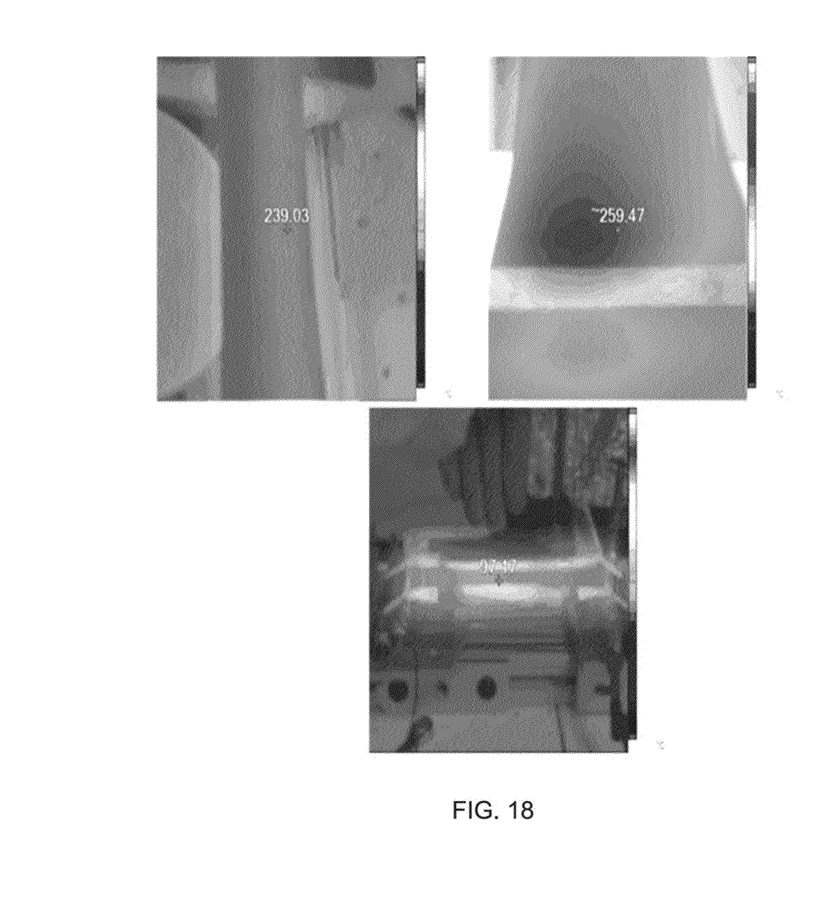

FIG. 17 shows applied current (and power)-temperature characteristics of stretched CNT sheet. The applied power-temperature curve may be highly linear between 0 to 80 W and the desired temperature achieved instantaneously when the required power is applied to the sheet. FIG. 18 shows 2-dimensional infra-red (IR) images with a representative temperature at certain location. The heating through RHAIC may be very localized. The temperature may easily increase to the desired temperature within very short period of time in air or in vacuum if required.

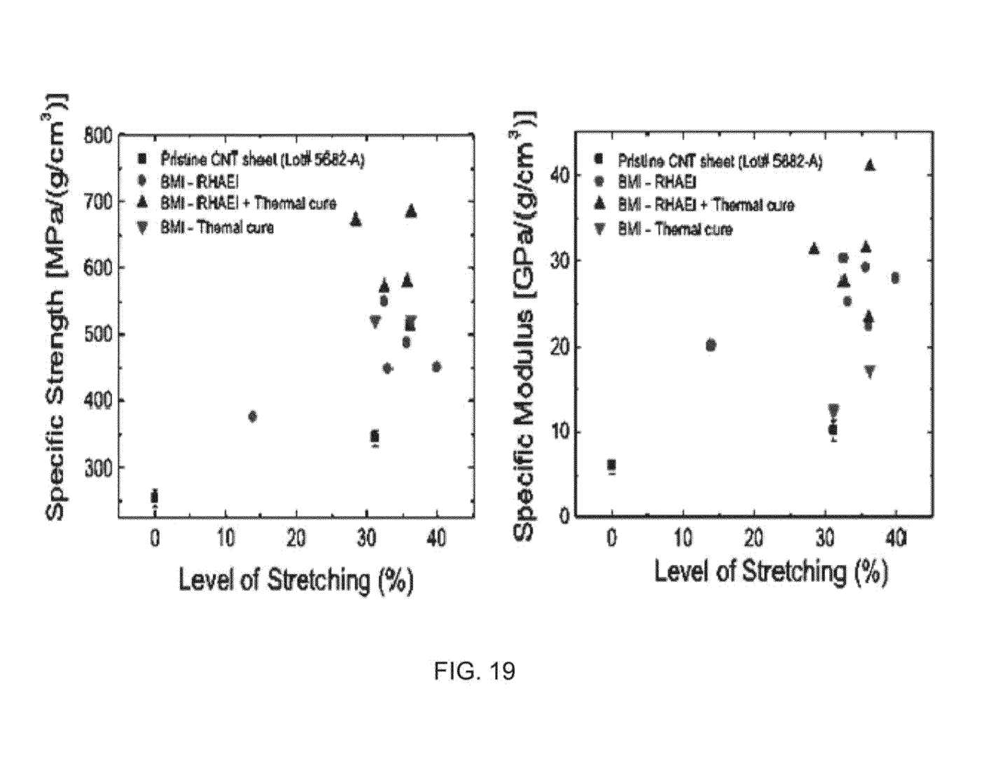

The BMI/CNT nanocomposites were prepared with various conditions such as various loading rates of BMI, various level of stretching, and various cure conditions. The prepared BMI/CNT nanocomposites were mechanically tested using a micro tensile tester and the resulting mechanical properties are summarized in FIG. 19. The mechanical properties of BMI/CNT composites fabricated by RHAIC for less than 30 min show both high tensile strength (˜500 MPa/(g/cm³)) and high Young's modulus (˜30 GPa/(g/cm³)). The specific strength of the BMI/CNT composites prepared by RHAI shows similar value in that of the thermally cured BMI/CNT composite while the Young's modulus is significantly enhanced by RHAIC process under a tension in a stretching machine to prevent relaxation of aligned CNTs during the infiltration of resin and thermal cure. The mechanical properties of BMI/CNT composites prepared by RHAIC are further enhanced through a post-cure process (close to 700 MPa/(g/cm³) in specific strength and 40 GPa/(g/cm³) in Young's modulus) or longer heating by RHAIC. These properties are some of the highest values obtained for CNT nanocomposites from the current generation of CNT sheets as documented in FIG. 19.

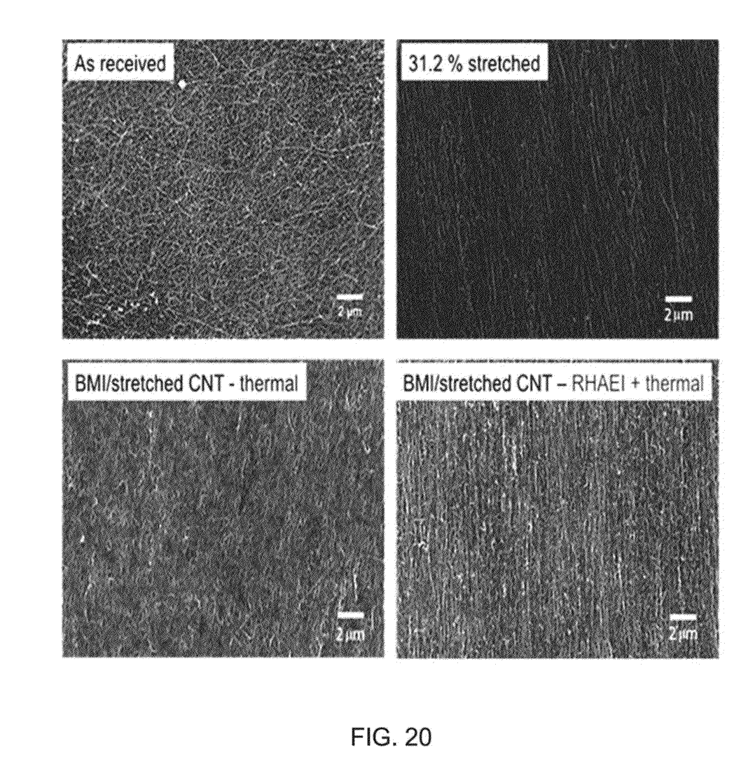

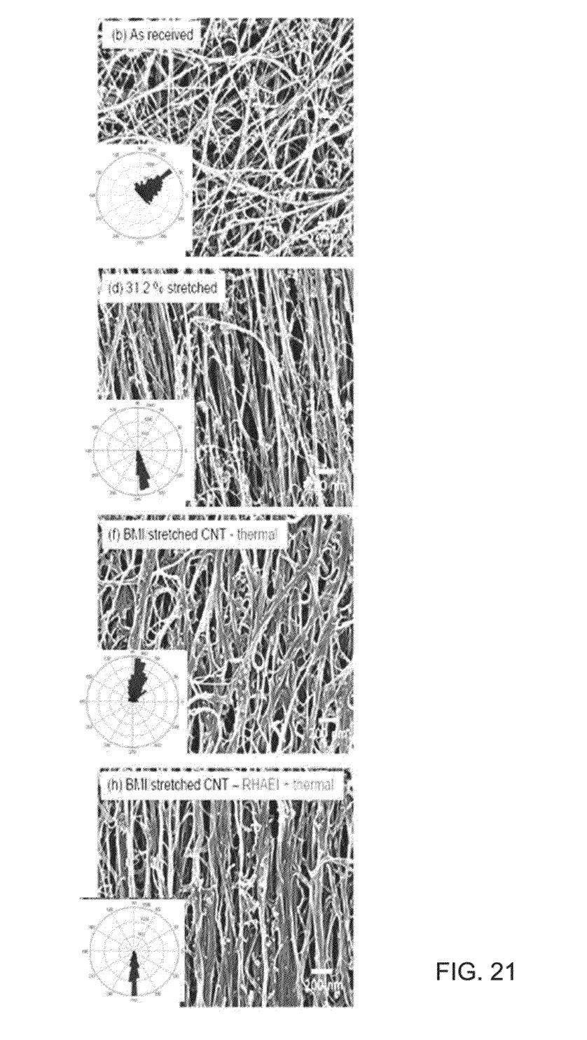

Overall, the BMI/CNT sheet nanocomposites fabricated by RHAIC were well coated by the BMI resin through the CNTs surfaces and interconnected between the CNT bundles through the thickness of the film as shown in FIGS. 20 and 21. FIGS. 20 and 21 show FE-SEM images of as-received, 31.2% stretched pristine CNT sheets, and BMI/stretched CNT sheet nanocomposites cured by thermal and RHAI followed by post-thermal cure. The inset in FIG. 21 is rose plots of the histogram of angular orientation obtained from each FE-SEM image. This method has high potential for much more significant enhancements of mechanical properties for CNT composites when used with more aligned and highly stretched CNT sheets without relaxation of aligned CNTs when the tensile load is removed during the post-cure. It is anticipated that as the quality of high volume CNT sheets improves, the advantages offered by this approach will be further highlighted.

Table 2 described the physical and mechanical properties of pristine and processed BMI/CNT sheet nanocomposites. All BMI/S-CNT sheet nanocomposites were fabricated with a stretched (33.99%) CNT (S-CNT) sheet.

TABLE 2

| | | BMI | | | Specific | Specific | Elongation |
|---|---|---|---|---|---|---|---|
| | | loading | Density | Thickness | strength | Modulus | at failure |
| Sample | Cure | (wt. %) | (g/cm³) | (μm) | [MPa/(g/cm³)] | [GPa/(g/cm³)] | (%) |
| 1 Pristine | | 0 | 0.735 | 15.1 | 254 ± 13 | 6 ± 1 | 31 ± 2 |
| (Lot# 5682- | | | | | | | |
| A) | | | | | | | |
| 2 BMI/CNT | Thermal | 33 | 0.756 | 23.5 | 357 ± 14 | 21 ± 2 | 16 ± 1 |
| sheet* | | | | | | | |
| 3 Stretched | | 0 | 0.882 | 15.7 | 367 ± 4 | 15 ± 0.1 | 7.3 ± 0.8 |
| CNT Sheet | | | | | | | |
| (33.9%) | | | | | | | |
| 4 BMI/S- | Thermal | 24 | 0.867 | 20.0 | 412 ± 3 | 32 ± 4 | 2.6 ± 0.2 |
| CNT sheet | | | | | | | |
| 5 BMI/S- | Thermal | 43 | 1.144 | 21.0 | 541 ± 9 | 31 ± 3 | 3.9 ± 0.1 |
| CNT sheet | | | | | | | |
| 6 BMI/S- | RHAIC | 18 | 0.836 | 21.3 | 461 ± 44 | 43 ± 3 | 5.1 ± 2.8 |
| CNT sheet | | | | | | | |
| 7 BMI/S- | RHAIC | 39 | 1.172 | 19.1 | 609 | 71 | 3.0 |
| CNT sheet | | | | | | | |

*The BMI/CNT sheet nanocomposite was fabricated with Lot# 70044.

Table 3 described the physical and mechanical properties of pristine and processed BMI/CNT sheet nanocomposites.

TABLE 3

| | | | | | Specific | Specific | Elongation |
|---|---|---|---|---|---|---|---|
| | | Stretching | Density | Thickness | strength | Modulus | at failure |
| Sample | Cure | level (%) | (g/cm³) | (μm) | [MPa/(g/cm³)] | [GPa/(g/cm³)] | (%) |
| Pristine | | 0 | 0.709 | 17.4 | 253 ± 4 | 5.8 ± 0.6 | 40 ± 1 |
| (Lot# | | | | | | | |
| 70044) | | | | | | | |
| BMI/CNT | Thermal | 0 | 0.756 | 23.5 | 357 ± 14 | 21 ± 2 | 16 ± 1 |
| sheet (1 | | | | | | | |
| ply) | | | | | | | |
| BMI/S- | RHAI + | 41 | 0.662 | 38.7 | 549 ± 22 | 49 ± 11 | 2.7 ± 1.0 |
| CNT | Thermal | | | | | | |
| Sheet (1 | | | | | | | |
| ply) | | | | | | | |
| BMI/S- | RHAI + | 33 | 1.004 | 40.6 | 467 ± 39 | 40 ± 3 | 2.0 ± 0.2 |
| CNT | Thermal | | | | | | |
| sheet (2 | | | | | | | |
| ply) | | | | | | | |
| BMI/S- | RHAI + | 36 | 0.663 | 57.9 | 509 ± 38 | 35 ± 3 | 4.2 ± 1.2 |
| CNT | Thermal | | | | | | |
| sheet (2 | | | | | | | |
| ply) | | | | | | | |
| BMI/S- | RHAI + | 48 | 0.701 | 40.2 | 578 ± 64 | 41 ± 7 | 2.5 ± 0.2 |
| CNT | Press- | | | | | | |
| sheet (1 | mold | | | | | | |
| ply) | | | | | | | |
| BMI/S- | RHAI + | 42 | 0.749 | 74.4 | 602 ± 30 | 52 ± 3 | 2.1 ± 0.5 |
| CNT | Press- | | | | | | |
| sheet (2 | mold | | | | | | |
| ply) | | | | | | | |

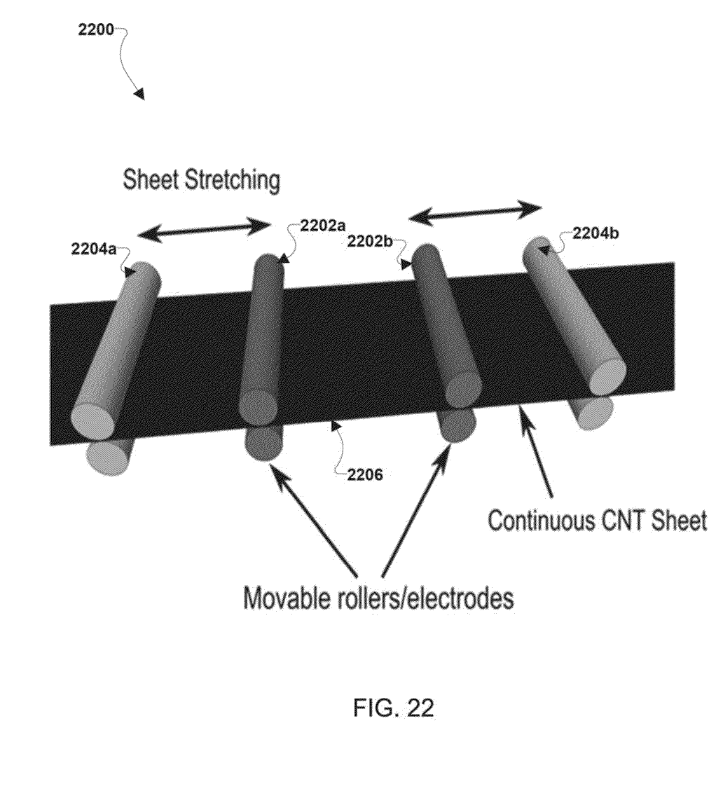

FIG. 22 is an isometric view of an embodiment moveable electrical conductive roller system 2200 for RHAIC processing of unlimited length material 2206, such as a continuous CNT sheet, tape, and yarn. Moveable, electrical conductive rollers 2202a and 2202b may be used as both current conduits and clamps for stretching and aligning the nanomaterial during RHAIC. The rollers 2202a and 2202b may stretch the sheet 2206 between the rollers 2202a and 2202b and the rollers 2204a and 2204b.

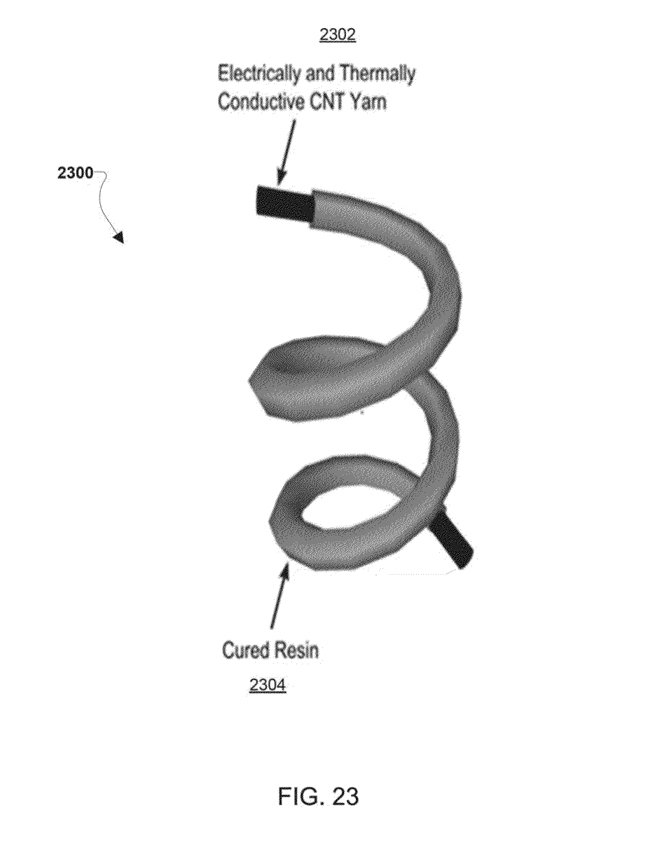

FIG. 23 is an isometric view of an example component 2300 formed by embodiment RHAIC processing. The RHAIC processing may allow for the formation of complex nanomaterial/cured resin components, such as component 2300. Rapid cure of the resin 2304 without the need for extensive equipment (e.g., only equipment to apply current to the electrically and thermally conductive nanomaterial, such as electrically and thermally conductive CNT yarn) may expand the freedom to form 3-D components and cure the resin in those forms.

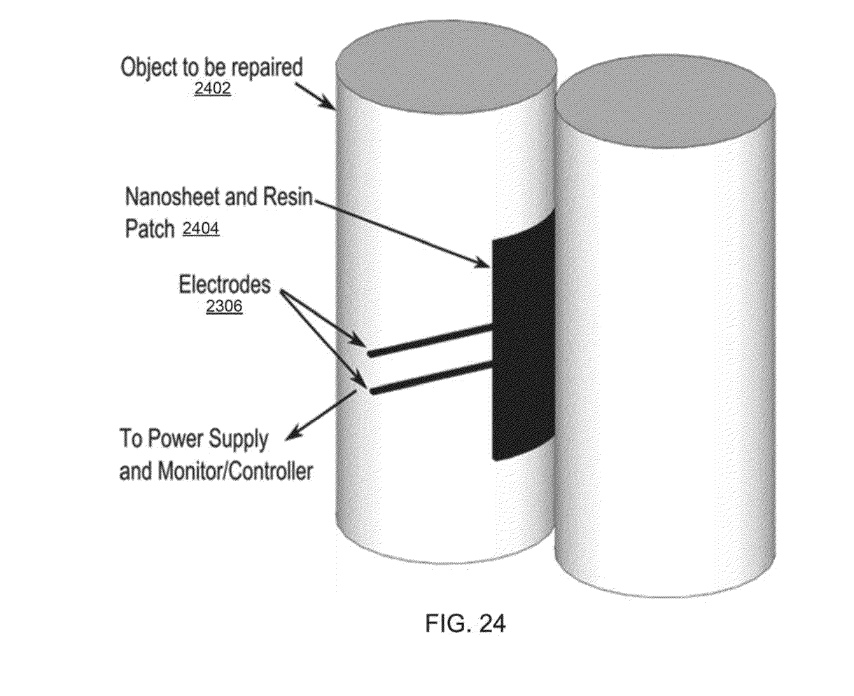

FIG. 24 is an isometric view of an object 2402 being repaired by embodiment RHAIC processes. The small footprint and short processing time of the RHAIC process may allow its use as a repair technique. For example, a nanosheet and resin patch 2404 may include electrodes 2406 for connecting the patch 2404 to a power supply and monitor/controller.

The various embodiments may provide utilization of efficient resistive heating conductive reinforcements not limited to carbon nanofillers. The various embodiments may provide utilization of efficient resistive heating thermally conductive reinforcements not limited to boron nanofillers such as boron nitride nanotube, h-boron nitride sheet, etc. The various embodiments may provide be extended and combined with electrically conductive and thermally conductive laminates. In the various embodiments, it may be easy to adjust cure cycling of various resin systems by using instant feedback via the power supply and monitoring system.

The rapid and localized cure enabled by RHAIC may allow the formation and freezing of complex shapes. The various embodiments may provide for processing of hybrid nanocomposites with thermally conductive but electrical insulating nano fillers such as boron nitride nano tubes, sheets and yarns can be achieved by adding a small proportion of electrical conductive CNT fibers as the current carriers. The various embodiments may provide the rapid processing turnaround time and small footprint (no ovens or other equipment required for the primary processing) that may allow the RHAIC process to be used for testing and optimizing the conditions of stretching as well as resin infusion and cure required for high strength composites. The small footprint of the embodiment RHAIC processes may allow its use as a composite repair technique that can be deployed in the field. The simplicity of the various embodiments also may be integrated in an automated fabrication system like 3-D printers designed to accommodate emerging material systems such as the CNT tapes derived from CNT sheets being used here to enable net shape fabrication of CNT reinforced articles. The various embodiments may provide research applications such as a rapid testing system for the investigation of controlled nanosheet alignment with resin application and cure under load. The embodiment RHAIC processes may also allow all stages of the process to be achieved with one apparatus.

In various embodiments, a bismaleimide (BMI) may be used for the matrix material, necessitating a post-cure thermal treatment at 240° C. for 6 h, if desired. Tensile tests were used to evaluate the mechanical properties of the processed thermoset/CNT sheet nanocomposites. The highest specific tensile strength obtained was 684 MPa/(g/cm³), using 4 V (2 A) for resin infiltration and 10 V (6 A) for 10 min for curing followed by thermal cure at 240° C. for 6 h. The highest specific Young's modulus achieved was 71 GPa/(g/cm³), using 8.3 V (2 A) for 3 min followed by curing at 12.5 V (6 A) for 30 min.

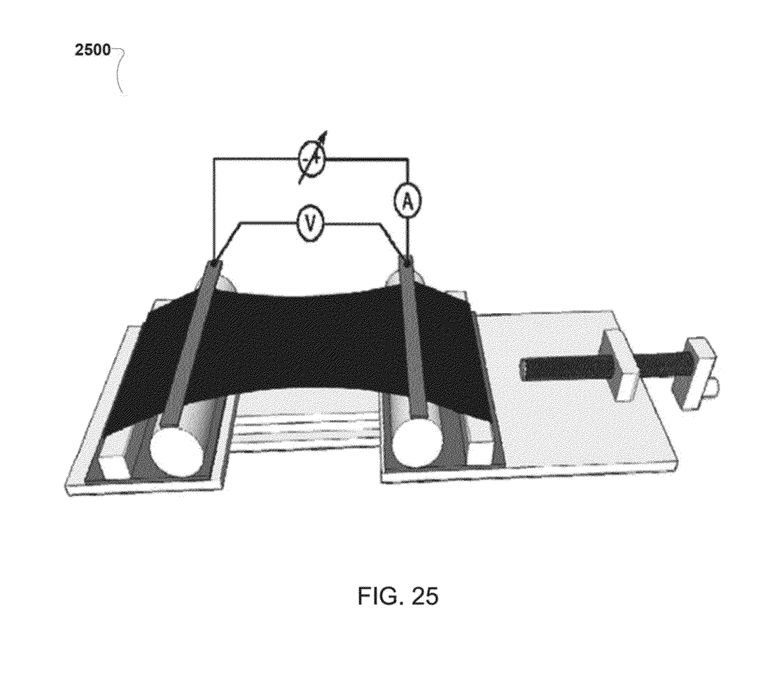

In resistive heating assisted infiltration and cure (RHAIC), all the necessary elements (stretching to align CNTs, applying the minimum amount of resin while completely wetting the CNTs, curing of the polymer resin to lock in alignment of the CNTs for effective load carrying capability) are done on a single device 2500 an example of which is illustrated in FIG. 25. It is also notable that all of the materials processing steps can be completed within an hour. The key difference is that the application of heat is done concurrently with the polymer addition, which allows steps 2-5 to be completed on the same setup. An additional oven curing step is only required if desired.

FIG. 17 described above shows a representative current-temperature and power-temperature characteristics of stretched (30%) CNT sheet with BMI resin (1 wt. % BMI in toluene). The applied power-temperature curve shows a linear relationship between 0 to 80 W. The desired temperature was achieved within a few seconds after power is applied to the CNT sheet. Varying the applied voltage allowed repeatable control of the sample temperature from room temperature up to 200° C. in air. The viscosity of applied resin was rapidly reduced at lower power levels to enable complete wetting and infiltration of the CNT sheet with polymer resin and removal of the solvent. Rapid resin curing may be achieved by subsequently increasing the power to reach the recommended cure temperature. The resistive heating approach allows for a rapid increase in temperature and, due to the close spacing of the CNTs in the sheet, efficient and uniform thermal transfer to enable rapid curing of the matrix resin. Completing the cure process while the composite is held in tension has the added advantage of locking in the alignment achieved by mechanical stretching of the CNT sheet. Removing the sample and placing it in an over for cure, as required by the typical approach, allows for partial relaxation of the alignment achieved during stretching.

FIG. 18 described above shows a 2-dimensional (2-D) infra-red (IR) image with a representative temperature at a stretched region of the CNT sheet during the RHAIC process. The image demonstrates the high degree of uniformity of temperature that is achieved using this technique. It should be noted, however, that maintaining a constant temperature during the cure process can be challenging due to changes in material emissivity and emergence and movement of hot zones. The surface temperature of the CNT sheet was measured based on an emissivity of 0.76 obtained from the graphite surface. Accurate resistive heating was achieved at a very localized area by controlling voltage, current, and power with a suitable controller. A custom LabVIEW based program was written to achieve the necessary fidelity to control the temperature.

For a detailed look at the wetting of the CNT sheet under resistive heating, a two-part resin system, SC-85, was used. All images in FIGS. 7, 8, and 10 discussed above, were collected real-time under an optical microscope. FIG. 7 shows the result of depositing the SC-85 resin and hardener components separately on the CNT tape surface. While the low viscosity hardener quickly wetted the CNT tape, the more viscous resin did not fully wet and infiltrate the CNT tape. FIG. 8 shows that mixing the resin and hardener prior to deposition still yielded viscosities that were too high to wet the CNT tape surface after application. The resin bead began to cure over time without significant penetration into the CNT tape and had almost completely hardened after 75 min. The hardener penetrated the CNT tape and accumulated on the backside of the tape (shiny residue on the backside surface), suggesting that in the course of the experiment, the less viscous hardener phase separated from the resin due to mismatches in viscosity of the components and their differing chemical affinities for the CNTs.

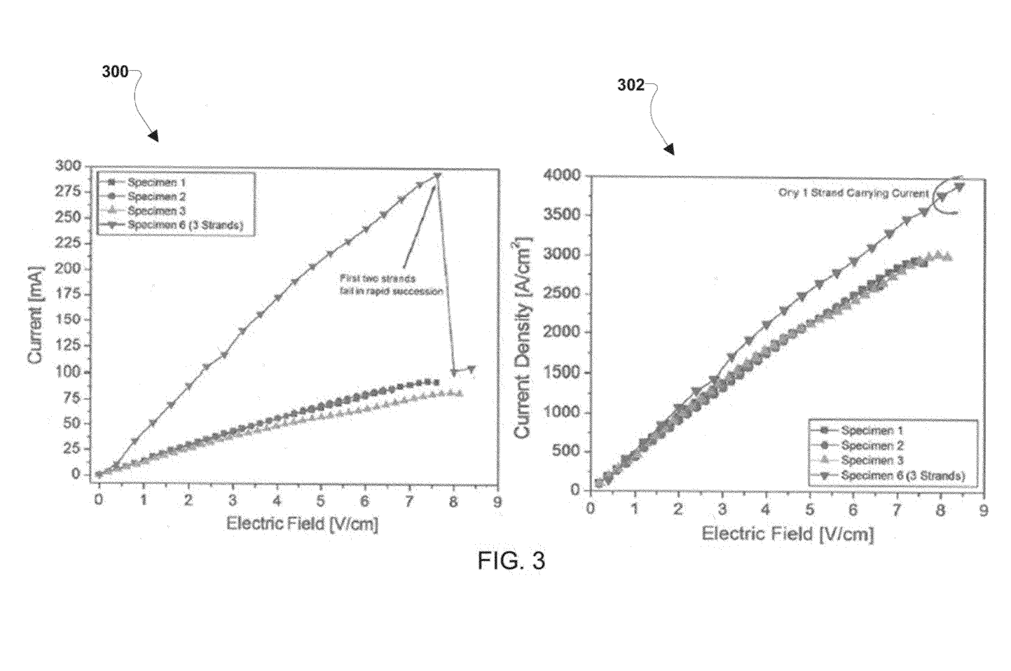

In contrast to these results, FIG. 10 shows that, when assisted by resistive heating, the SC-85 resin and hardener mixture wetted through the CNT tape uniformly. The series of images in FIG. 10 indicates that the extent infiltration and curing of SC-85 resin increases with increasing applied voltage, as reflected in the differences in transparency of the resin drops (clear to opaque). The lower applied voltage (3 V), center image in FIG. 3, produced a temperature change in the CNT sheet sufficient to lower the viscosity of the resin mixture and promote uniform wetting within a few tens of seconds, but did not raise it enough to initiate curing. Further increasing the applied voltage to 5 V resulted in curing of the resin within a short period of time, as indicated by transparency change. In neither case was evidence of phase separated hardener residue observed on the backside of the CNT.

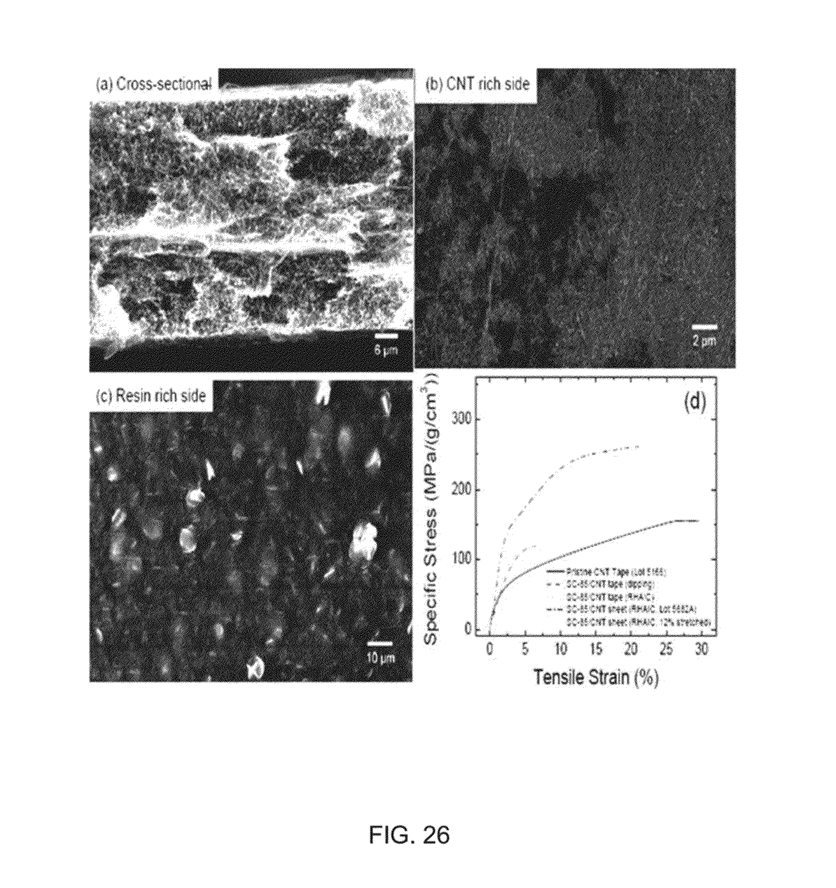

Based on the results of the droplet experiments, SC-85/CNT sheet nanocomposite fabrication was performed with premixing of the resin and hardener and by using RHAIC to promote infiltration and cure. Morphologies of the fabricated SC-85/CNT sheet nanocomposites and their mechanical properties are summarized in FIG. 26. FIG. 26 shows that the SC-85/CNT sheet nanocomposites were well wetted and that interconnections between CNT bundles formed throughout the thickness of the film. FIG. 26 also demonstrates that applying the resin to only one side results in resin poor and resin rich sides of the composite. Despite this shortcoming, improvements of mechanical properties were significant.

The measured specific tensile strength and specific Young's modulus of pristine CNT tape (Lot#5166) were 156±11 MPa/(g/cm³) and 6.1 f 1.5 GPa/(g/cm³), respectively, and elongation at failure was 30±8%. The mechanical properties of thermally cured SC-85/CNT nanocomposite were poor for both the tensile strength [119 MPa/(g/cm³)] and modulus [3.4 GPa/(g/cm³)] when the process was completed without RHAIC. Both poor wetting (thick resin rich layer) and poor adhesion of the resin to the CNT tape were noted. In comparison, the specific tensile strength of SC-85/CNT nanocomposites fabricated from CNT tape by RHAIC was 218 MPa/(g/cm³). Employing acetone condensation to densify the CNT sheet prior to nanocomposite fabrication by RHAIC increased the specific strength to 284 MPa/(g/cm³). A mechanically stretched and acetone condensed CNT sheet yielded even higher specific strength [347 MPa/(g/cm³)]. The Young's modulus of RHAIC processed SC-85/CNT sheet nanocomposites also increased to 10.1 and 14.5 GPa/(g/cm³) with unstretched acetone treated and stretched acetone treated CNT sheets, respectively. The specific tensile strength below 10% strain dramatically increased due to better adhesion of the resin to the CNT surfaces. The SC-85/CNT sheet nanocomposites fabricated by RHAIC also exhibited improved toughness of 55 (unstretched) and 45 J/g (stretched) compared with that produced by dipping process followed by thermal cure with untreated CNT tape (5.3 J/g). Note that the toughness of untreated and acetone treated CNT sheets were 35 and 51 J/g, respectively.

BMI, another thermoset system commonly used for engineering composites, was also investigated. Bismaleimide (BMI) was dissolved in toluene (or methyl ethyl ketone, MEK) to promote its ability to wet the CNT sheet. Solvents with proper boiling points and volatility, such as toluene (b.p.: 111° C.) and MEK (b.p.: 80° C.), have the advantage of keeping the CNT sheet wet during the resin infiltration step at lower applied voltage and quickly evaporating when the applied voltage is increased to initiate curing. The images in FIG. 26 were taken with an optical microscope during infiltration of a BMI/toluene solution into the CNT sheet. The infiltration phase of the RHAIC process was conducted at 7 V (0.6 A), followed by cure at 13V (1.2 A). The BMI solution quickly wetted and infiltrated the CNT sheets within 20 sec. The residual toluene evaporated within a few tens of seconds at the elevated temperature reached by resistive heating. Subsequently increasing the applied voltage to 13 V increased the local temperature of the CNT sheet to initiate cure of the resin. Note that following this elevated temperature treatment, the BMI residue that was visible after solvent evaporation was no longer present.

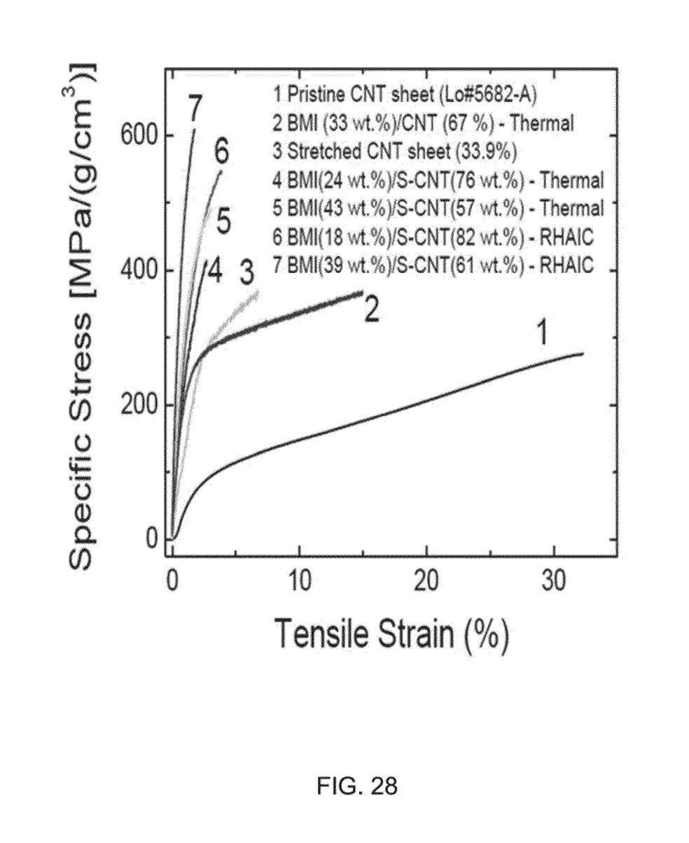

A series of BMI/CNT sheet nanocomposites were prepared to study the effects of various conditions such as BMI loading levels, level of stretching, and cure conditions, and mechanically tested to determine their tensile properties (Table 2). Representative stress-strain curves of as-received and stretched CNT sheets, conventionally cured BMI/CNT sheet, and RHAIC-cured BMI/CNT sheets with different loading levels of BMI are shown in FIG. 28. The effect of mechanical stretching alone can be seen by comparing traces 1 and 3. Upon stretching by 33.9%, the specific strength increased from 254 to 367 MPa/(g/cm³) and the Young's modulus increased from 5.9 to 14.5 GPa/(g/cm³), which is in good agreement with the literature. Further increases of tensile strength and modulus were achieved by BMI infiltration, both with lower (˜20%, traces 4 and 6) and higher (˜40%, traces 5 and 7) loading levels of BMI. This was observed in both thermally cured (traces 4 and 5) and RHAIC processed (traces 6 and 7) nanocomposites. In general, the specific strength and modulus of the BMI/CNT composites prepared by RHAIC were greater than those obtained from thermally curing when using similar degrees of BMI loading and CNT stretching. The greatest enhancement of mechanical properties was achieved with a BMI loading content of ˜40 to 50%, using stretched CNT sheets as the reinforcement, and the RHAIC method. To some extent, the improved properties observed in the RHAIC cured sheets arise from the fact that they are held in their stretched configuration while curing. The traditionally cured samples are, in contrast, removed from the stretching rig and placed in an oven to cure, which allows some degree of relaxation of the stretch-induced alignment of the CNTs in these samples. Being able to cure the sheets in their stretched configuration is one of the attractive features of the RHAIC method.

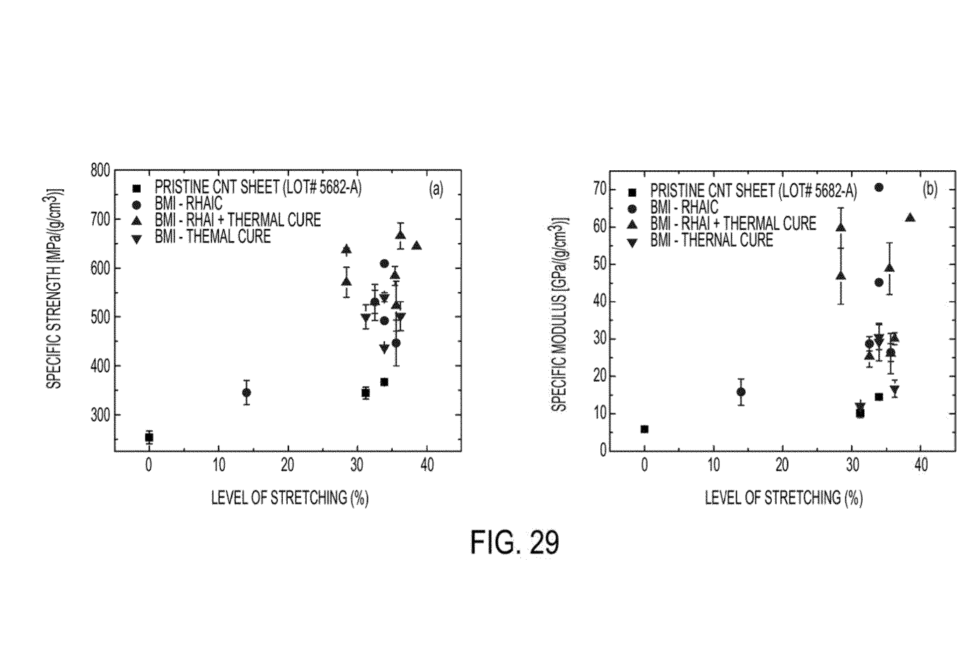

All of the specific strength and modulus data for the various processing treatments are collected in FIG. 29. The mechanical properties are plotted as a function of the extent of stretching in an attempt to disentangle the effects of stretching from the other processing variables. Increasing the alignment of the CNT bundles in the pristine sheets by stretching clearly results in moderate improvements in strength and modulus. Adding BMI to the stretched sheets without resistive heating, followed by thermal curing, results in substantial improvements in strength and smaller increases in modulus. Much larger increases in strength and modulus result from the use of resonant heating when adding the matrix polymer, regardless of whether an oven or resistive heating is used to cure the matrix. These improvements reflect the significantly improved infiltration and wetting that occurs when using RHAI. The data in FIG. 29 indicates that the highest specific strength values were obtained by resistive heating followed by thermal curing in an oven. For specific modulus on the other hand, the best results were achieved when the material was cured using resistive heating. As mentioned above, this is not surprising because curing the material in the stretching rig prevents relaxation of CNT bundle alignment, which has a much larger impact on modulus than strength.

In view of the strong dependence of the measured mechanical properties on the extent of stretching, it is important to quantify the effect of stretching on CNT bundle orientation. The FE-SEM images shown in FIGS. 20 and 21 described above, have been used to calculate 2D order parameters (S) for four representative samples produced in this study. Included are high magnification images of the pristine CNT sheet before and after stretching by 31.2%. The visually obvious increase in alignment from the relatively unaligned as-received sheet to the stretched sheet is reflected in the increase of the order parameter from S=0.240 to S=0.796. Also note that the CNT sheet was significantly densified along the x-y plane and thickened somewhat due to the auxetic behavior of CNT sheet during the stretching. Adding BMI to the stretched sheet without RHAI and curing in an oven results in the structure shown in the picture labeled “BMIstretched CNT-thermal”. Relaxing tension prior to curing the material clearly results in the loss of some orientation, which is confirmed by a reduction in of the order parameter to S=0.541. If, instead, the tension is maintained and the CNT sheet is infiltrated and partially cured using RHAI, much of the orientation is maintained and the order parameter is found to be S=0.789.

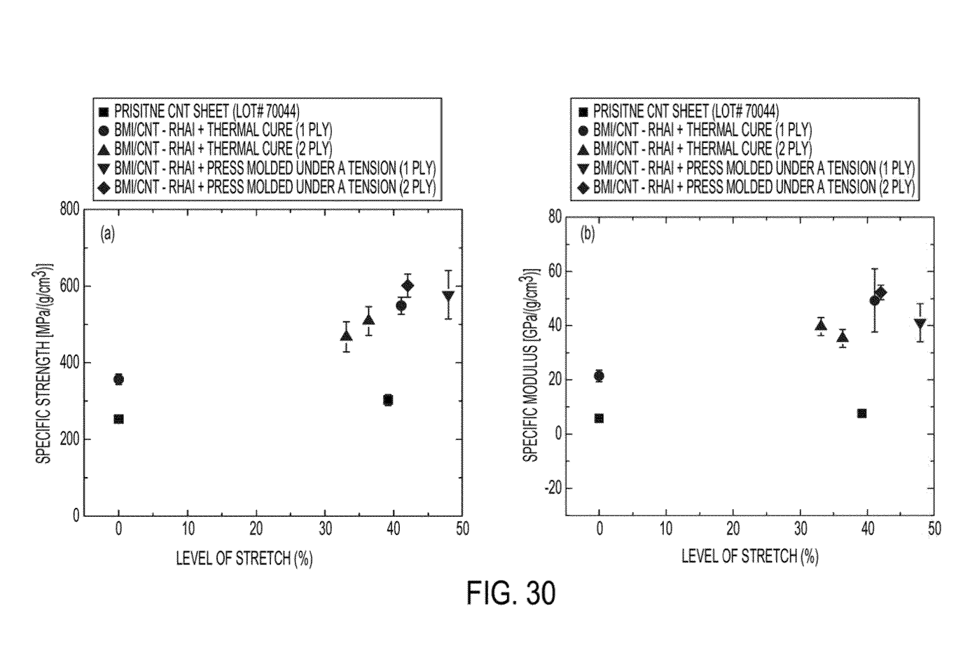

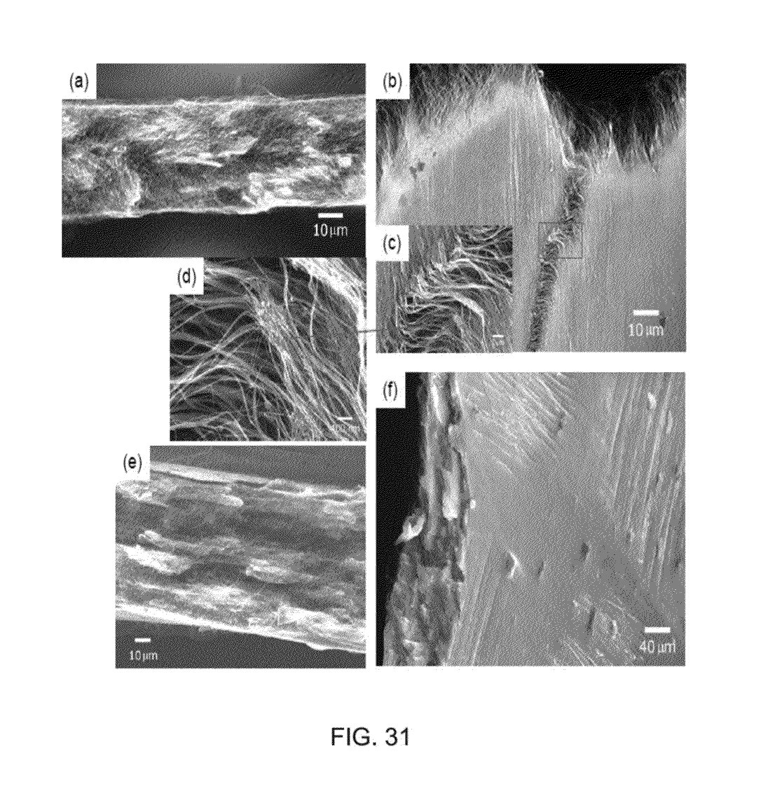

Demonstrating the effectiveness of the RHAI processing method for a single layer CNT sheet is an important proof of concept, but any practically application will require the fabrication of much thicker composites. As a first step in this direction, BMI/CNT sheet nanocomposites were prepared with two layers of CNT sheets by RHAI followed by thermal cure, both with and without press-molding. Two layers of CNT sheet were overlaid and then stretched to the desired degree. One set of the stretched CNT sheets was then processed by RHAI followed by thermal cure as described above for the single sheets. A second set of stretched and BMI infiltrated CNT sheets was clamped, transferred to the mold under tension, and then post-cured under high pressure (500 psi, 3.44 MPa). The resulting mechanical data are summarized in Table 3 and FIG. 30. In view of the different degrees of stretching that were achieved in the various samples and the error bars associated with their values, it's difficult to draw any sweeping conclusions from these results. It is, however, encouraging that adding a second layer did not measurably reduce properties relative to the single sheet composites. This indicates that the two layer composites did not have a significant resin rich layer, which can promote failure by interlayer delamination. This inference is supported by the FE-SEM images shown in FIG. 31.

Pristine CNT sheets have been shown to fail in various ways, including breaking, sliding, debundling, telescoping, and delamination. With the addition of the BMI resin, the BMI-coated CNT bundles were partially broken first and then the CNTs subsequently telescoped and slid from the CNT bundles or individual tubes while under a continuous tensile load. Partially telescoped and broken CNTs and CNT bundles, which had cleaner and thinner surfaces, bridged the developed cracks until complete failure of the material. Because of this failure mechanism, the mechanical properties of the nanocomposites could be further enhanced by chemical functionalization of CNT surfaces to provide covalent bonding between the infiltrated resin and CNT and with inter-/intra-tube bonding of CNTs by electron beam irradiation. Additional studies are underway to examine the potential of resistive heating assisted nanocomposite fabrication to further enhance the mechanical properties of CNT sheet nanocomposites using purified (catalyst removed) and/or chemically functionalized CNT sheets.

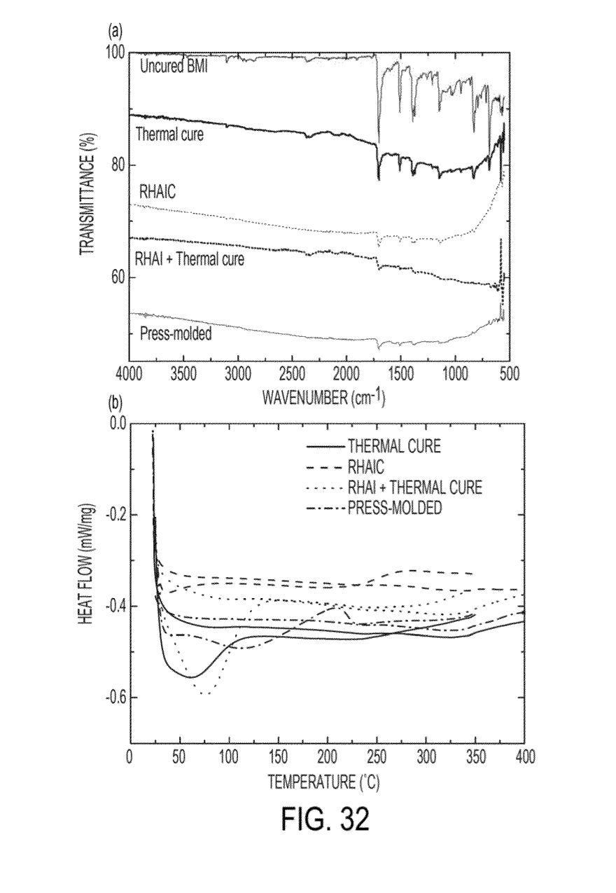

In order to investigate the extent of cure of the BMI resin achieved with the resistive heating method, FTIR and DSC experiments were conducted on several nanocomposite samples. FIG. 32 illustrates comparison graphs of FTIR spectra of uncured BMI/CNT and as-prepared BMI/CNT sheet nanocomposites via thermal cure, RHAIC, RHAI followed by thermal cure, and press-molded cure and DSC thermographs of as-prepared BMI/CNT sheet nanocomposites via thermal cure, RHAIC, RHAI followed by thermal cure, and press-molded cure. The specimens were fabricated by stretching CNT sheets to 40% of their original length, then infiltrating with the BMI solution and drying. By FTIR, the uncured BMI/CNT sample exhibited strong adsorption bands around 1709 (imide carbonyl), 1510 (phenyl ring), 1393 (imide ring) and 833 cm⁻¹ (phenyl and maleimide ring). After thermally curing for 6 h at 240° C., these adsorption bands were still evident, albeit at reduced intensities. After curing by RHAIC (10V, 7 A for 30 min), small adsorptions are apparent around 1709, 1600 and 1511 cm⁻¹, but much less intense than those from the thermal cure. In addition, the fingerprint region (1000-500 cm⁻¹) is devoid of any peaks, indicating complete cure of the BMI resin. The spectra for the specimen cured by RHAI followed by thermal cure (240° C., 6 h) and the sample prepared by press molding are nearly identical to that of the RHAIC cured specimen. The FTIR results indicate that the specimens treated by RHAIC have achieved a complete degree of cure in a significantly reduced time period compared to thermal cure.

The same BMI/CNT specimens were also characterized by DSC. The samples were heated to 350° C., quenched in liquid nitrogen and subsequently heated to 400° C. Except for the press-mold processed sample, none of the samples showed significant transitions, exhibiting only minor changes in the baseline at around 250 to 300° C. On the first run of the press-molded sample, an exothermic peak centered near 220° C. was apparent, but disappeared on the second run. No glass transitions (Tg) were apparent in any of the samples, which is not uncommon in thermosetting CFRPs. Typically Tgs are measured in CFRPs using dynamic mechanical thermal analysis. The DSC results support the FTIR data indicating that the RHAIC process cures the BMI to an extent equal to or greater than the other cure methods investigated.

Various nanocomposite fabrication processes intended to enhance the mechanical properties of CNT sheet nanocomposites for structural applications were investigated and demonstrated. These included mechanical stretching, resin infiltration, curing by resistive heating, and combinations thereof. The CNTs and CNT bundles were aligned and densified by mechanical stretching. CNT alignment was effectively locked in with polymer resin by employing a resistive heating process to achieve rapid and efficient resin wetting and partial cure. This process was shown to improve load transfer through prevention of shear sliding between the tubes, as well as between the CNT layers. Using the resistive heating process, the time to fully cure thermosetting resins can be significantly reduced. This fabrication method is not limited to thermoset matrices, but can be applied to other classes of polymers where an increase in resin temperature yields a lower viscosity. While the example studied used CNT sheet reinforcement, this method can be applied to other reinforcements such as highly densified CNT yarns or fuzzy carbon fibers.

The CNT starting materials used in this work were in the form of either an acetone treated CNT sheet [Lot#5682-A (catalyst content: 10.8 wt. %, average areal density: 10.00 g/m²), Lot#70044 (catalyst content: 10.4 wt. %, average areal density: 11.61 g/m²)] or a 0.3125 inch wide tape (Lot#5166, thickness: 20 μm, catalyst content: 9.8 wt. %, average areal density: 13.90 g/m²) all purchased from Nanocomp Technologies, Inc. Thermosets used were SC-85 (two part epoxy system, Applied Poleramic, Inc., USA, cure temperature: 38° C. for 2 h and 71° C. for 6 h post-cure) and bismaleimide (BMI, RM-3010, Renegade Materials Corp., recommended cure condition: cure at 135° C. for 2 h; ramp to 182° C.; hold 6 h; and post cure at 240° C. for 6 h). Toluene (Fisher Scientific, 99.9%) and methyl ethyl ketone (MEK, Sigma-Aldrich) were used as received.

While the CNTs in the Nanocomp CNT sheet are largely randomly oriented, there is some directionality present as a result of the manufacturing process. All mechanical tests and stretching were conducted along this processing alignment direction. Generally, an as-received CNT sheet cut to 7×3 inch (17.78 cm×7.62 cm) was used for fabrication of BMI/CNT sheet nanocomposites. The sheet was clamped on a custom built stretcher between two metal bars and then manually stretched to the desired level of stretching under ambient conditions. The level of stretching was calculated using length differences of marked lines [3 inch (7.62 cm) gap] at the center of the sheet before and after stretching.

Some of the CNT sheets used in this work were stretched with a custom-designed stretcher prior to the polymer infiltration step. The SC-85/CNT sheet nanocomposites were produced by painting the CNT sheet (pristine, acetone treated CNT sheet, or pre-stretched CNT sheets) with SC-85 (resin and hardener mixture) followed by RHAI. Increasing the applied voltage resulted in elevating the temperature to effect curing of the epoxy. The BMI/CNT sheet nanocomposites were fabricated by infiltration of the acetone treated (or its stretched) CNT sheet with a solution of BMI in toluene or MEK at various concentrations (0.01˜2 wt. %), followed by RHAIC. The desired voltage was then applied through the sample to increase its temperature by resistive heating with the current through the sample being monitored. An Agilent E3632A 120 W DC power supply was used for the heating. The applied voltage changed the local temperature of the CNT sheet and aided BMI infiltration through the CNT sheet and solvent evaporation, thus resulting in improved wettability and adhesion of the infiltrated BMI onto the CNT surfaces. Further increasing the applied voltage resulted in curing the BMI to lock in the aligned CNT networks or arrays. Temperature during processing of the material was monitored using a Fluke VT02 Handheld Visual IR thermometer and Fluke 561 IR thermometer. The infiltrated CNT sheets were cured by either the conventional thermal method, RHAI followed by thermal cure, or RHAIC (resistive heating only, no additional thermal treatment). The thermal cure was conducted in an air oven at 240° C. for 6 h. RHAI consisted of two steps involving BMI infiltration at a lower applied voltage (3-5 V) for 3 min followed by pre-cure at a higher applied voltage (10-15 V) for 5 min and then post curing at 240° C. for 6 h. RHAIC was of higher applied voltage for a longer period of time (at least 30 min) to ensure that the cure process was complete.

Room temperature tensile properties of the pristine CNT sheet, SC-85/CNT, and BMI/CNT nanocomposites were determined using a micro tensile tester or MTS-858 with a laser extensometer. An Instron 5848 Microtester was used to measure force-displacement data of the pristine CNT sheets and lower strength materials and the specific elastic modulus, specific ultimate strength, and ultimate tensile strain were subsequently calculated. MTS-858 equipped with a hydraulic grip and a laser extensometer was used to test higher strength materials. This provides more accurate modulus data of the materials since errors associated with sample slip in the grip were eliminated. Tensile stress was calculated by dividing the measured force by the cross-sectional area of the specimen determined with a profilometer type instrument (Mitutoyo Corp., Model ID-S112PE) that measures film thickness and confirmed by microscopic measurements. All mechanical data were normalized by the density of the specimen, which was determined by measuring the length, width, thickness, and weight of the specimen. The tensile testing methods were based on modified ASTM standards D882 (standard test method for tensile properties of thin plastic sheeting), D638 (standard test method for tensile properties of plastics), and D1708 (standard test method for tensile properties of plastics by use of microtensile specimens). The gage length was set at 10 mm for both the Instron (gap between the grips) and MTS-858 tensile tester (gap between two reflective tapes). The crosshead speed was 10 mm/min and 0.5 mm/min for pristine CNT sheets and polymer nanocomposites, respectively. The tensile samples were 5 mm wide rectangular strips. At least 5 specimens were tested to determine tensile strength and modulus. The Young's modulus was calculated by linear regression at the maximum slope and slope between 10 and 30% of ultimate strength at the corresponding stress-strain curve for the data obtained from crosshead displacement and a laser extensometer, respectively. Toughness was calculated by measuring the area under the stress-strain curve up to material failure. The measured density of SC-85/CNT sheet nanocomposites was 0.983±0.057 g/cm³.

A field emission-electron microscope (FE-SEM, Hitachi Model S-5200) was used to image as-prepared polymer/CNT sheet nanocomposites and cross-sectional samples of failed specimens after tensile tests. A digital optical microscope (Mighty Scope) connected and controlled by Camtasia Studio 7 software (TechSmith Corporation) was used for monitoring in-situ wetting and curing experiments of both SC-85 and BMI resin systems. Differential scanning calorimetry (DSC, Netzsch, Model DSC 204 F1) was carried out under nitrogen (20 ml/min) at heating rate of 10° C./min. DSC thermographs were obtained by ramping to 350° C. followed by immediate quenching of the sample in liquid nitrogen. The same sample was then scanned again from room temperature to 400° C. The chemical structure of the BMI/CNT sheet nanocomposites prepared by various cure conditions was studied using Fourier transform-infrared (FTIR, Thermo Nicolet, Model IR300) spectroscopy. FTIR was carried out with as-prepared BMI/CNT sheet nanocomposites in an optical range of 500-4000 cm⁻¹.

The 2-D order parameter is equivalent to the Herman's order function for 3-dimensional systems and was determined by analysis of SEM images as follows: The edges of the aligned CNTs were detected as elliptical features by using the Canny edge detector in the Matlab GAIS-V2 tool. Around 1000 elliptical features were extracted from each SEM image to calculate the average angle. The average angle was based on an ellipse area weighted order, which was represented as a rose plot of the histogram of angular orientations. The 2-D order parameter (S=<2 cos²β−1>) of the aligned CNTs was calculated with using average angles, β, between the local director and the main CNT aligned axis.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” As used herein, the term “and/or” includes any and all combinations of one or more of the associated listed items. As also used herein, the term “combinations thereof” includes combinations having at least one of the associated listed items, wherein the combination can further include additional, like non-listed items. Further, the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

Reference throughout the specification to “another embodiment”, “an embodiment”, “exemplary embodiments”, and so forth, means that a particular element (e.g., feature, structure, and/or characteristic) described in connection with the embodiment is included in at least one embodiment described herein, and can or cannot be present in other embodiments. In addition, it is to be understood that the described elements can be combined in any suitable manner in the various embodiments and are not limited to the specific combination in which they are discussed.

What is claimed is:

1. A method for fabricating nanocomposites, comprising:
applying a matrix resin to a reinforcement material to infuse the reinforcement material with the matrix resin;
applying a first voltage to the matrix resin infused reinforcement material; and
applying a second voltage higher than the first voltage to the matrix resin infused reinforcement material.

2. The method of claim 1, wherein the reinforcement material is a carbon nanotube (CNT) assemblage.

3. The method of claim 2, wherein matrix resin is a thermoset or thermoplastic.

4. The method of claim 3, wherein:
the reinforcement material is unstretched or stretched at least 30%; and
the matrix resin is dissolved in a solvent.

5. The method of claim 4, further comprising applying a post cure thermal treatment after applying the second voltage.

6. The method of claim 5, wherein the post cure thermal treatment comprises heating the matrix resin infused reinforcement material up to 300° C. for at least two hours.

7. The method of claim 3, further comprising:
applying a post cure thermal treatment after applying the second voltage; and
continuing to stretch the matrix resin infused reinforcement material until after pre-cure by resistive heating is completed.

8. The method of claim 3, wherein the matrix resin is a thermoset selected from the group consisting of a bismaleimide (BMI) or SC-85.

9. The method of claim 2, wherein the reinforcement material is untreated, acetone treated, or nitric acid treated.

10. The method of claim 2, wherein the CNT assemblage is a CNT sheet, CNT yarn, or CNT tape.

11. The method of claim 1, wherein the reinforcement material is comprised of carbon fibers.

12. The method of claim 1 wherein the matrix resin comprises a resin and a loading of fillers selected to improve the resin's thermal conductivity and mechanical interlocking.

13. The method of claim 12, wherein the fillers are selected from the group consisting of carbon nanotubes, graphene sheets, boron nitride nanotubes, and boron nitride nanosheets.

14. The method of claim 12, wherein the loading of the fillers is between 0 and 20 wt %.

15. The method of claim 1, wherein the matrix resin is applied by painting, dipping, soaking, or spray coating.

16. A system for fabricating nanocomposites, comprising:
a voltage source;
two electrodes connected to the voltage source and configured to provide a voltage to a matrix resin infused carbon nanotube (CNT) material stretched between the two electrodes; and
a processor connected to the voltage source, the processor configured with processor executable instructions to perform operations comprising:
controlling the voltage source to apply a first voltage to the matrix resin infused CNT material; and
controlling the voltage source to apply a second voltage higher than the first voltage to the matrix resin infused CNT material.

17. The system of claim 16, wherein:
the first voltage is a voltage ranging from 2 volts to 10 volts;
the second voltage is a voltage ranging from 5 volts to 20 volts;
the matrix resin is SC-85 or a bismaleimide (BMI); and
the CNT material is a CNT sheet or CNT yarn.

18. The system of claim 17, wherein the two electrodes are moveable rollers.

19. The system of claim 16, wherein the matrix resin infused CNT material is a nanosheet and resin patch.

20. The system of claim 16, wherein the matrix resin comprises a resin and a loading of fillers selected to improve the resin's thermal conductivity and mechanical interlocking.
